(19) United States
(12) Patent Application Publication
(10) Pub. No.: US 2026/0143436 A1
(43) Pub. Date: May 21, 2026

(54) POWER REDUCTION IN WIRELESS COMMUNICATION SYSTEMS

(71) Applicant: Samsung Electronics Co., Ltd., Suwon-si (KR)

(72) Inventors: Marian Rudolf, Longueuil (CA); Aristides Papasakellariou, Houston, TX (US)

(21) Appl. No.: 19/370,285

(22) Filed: Oct. 27, 2025

Related U.S. Application Data
(60) Provisional application No. 63/720,915, filed on Nov. 15, 2024.

(51) Int. Cl. H04W 52/36; H04W 72/044; H04W 72/21

(52) U.S. Cl. CPC H04W 52/367; H04W 72/044; H04W 72/21

(57) ABSTRACT

Apparatuses and methods for power reduction in wireless communication systems. A method for operating a user equipment (UE) includes receiving first information related to a first uplink (UL) carrier and a second UL carrier, receiving second information associated with a maximum power reduction (MPR) mitigation mode, and determining, based on the first and second information, first and second UE maximum output powers for an UL transmission bandwidth according to first and second MPR values. The first and second MPR values are associated with first and second transmissions on the first and second UL carriers. The method further includes determining first and second UL transmit powers based on the first and second UE maximum output powers, respectively, and transmitting an UL signal or channel on the first UL carrier based on the first UL transmit power on the second UL carrier based on the second UL transmit power.

### CROSS REFERENCE TO RELATED APPLICATIONS AND CLAIM OF PRIORITY

The present application claims priority under 35 U.S.C. § 119(e) to U.S. Provisional Patent Application No. 63/720,915 filed on Nov. 15, 2024, which are hereby incorporated by reference in their entirety.

### TECHNICAL FIELD

The present disclosure relates generally to wireless communication systems and, more specifically, to power reduction in wireless communication systems.

### BACKGROUND

6th generation (6G) is recently gathering increased momentum with all the worldwide technical activities on the various candidate technologies from industry and academia. The candidate enablers for the 6G mobile communications include massive antenna technologies, from legacy cellular frequency bands up to high frequencies, to provide beamforming gain and support increased capacity, waveform design to flexibly accommodate various services/applications with different requirements, new multiple access schemes to support massive connections, AI/ML, and so on.

### SUMMARY

The present disclosure relates to power reduction in wireless communication systems.

In one embodiment, a method for operating a UE is provided. The method includes receiving first information related to a first uplink (UL) carrier and a second UL carrier, receiving second information associated with a maximum power reduction (MPR) mitigation mode, determining, based on the first and second information, a first UE maximum output power for an UL transmission bandwidth according to a first MPR value, and determining, based on the first and second information, a second UE maximum output power for an UL transmission bandwidth according to a second MPR value. The first MPR value is associated with a first transmission on the first UL carrier. The second MPR value is associated with a second transmission on the second UL carrier. The method further includes determining a first UL transmit power and a second UL transmit power based on the first and second UE maximum output powers, respectively, and one of transmitting, based on the first UL transmit power, an UL signal or channel on the first UL carrier or transmitting, based on the second UL transmit power, the UL signal or channel on the second UL carrier.

In another embodiment, a UE is provided. The UE includes a transceiver configured to receive first information related to a first UL carrier and a second UL carrier and receive second information associated with a MPR mitigation mode. The UE further includes a processor operably coupled to the transceiver. The processor is configured to determine, based on the first and second information, a first UE maximum output power for an UL transmission bandwidth according to a first MPR value, determine, based on the first and second information, a second UE maximum output power for an UL transmission bandwidth according to a second MPR value, and determine a first UL transmit power and a second UL transmit power based on the first and second UE maximum output powers, respectively. The first MPR value is associated with a first transmission on the first UL carrier. The second MPR value is associated with a second transmission on the second UL carrier. The transceiver is further configured to one of transmit, based on the first UL transmit power, an UL signal or channel on the first UL carrier or transmit, based on the second UL transmit power, the UL signal or channel on the second UL carrier.

In yet another embodiment, a base station (BS) is provided. The BS includes a processor and a transceiver operably coupled with the processor. The transceiver is configured to transmit, to a UE, first information related to a first UL carrier and a second UL carrier, transmit, to the UE, second information associated with a MPR mitigation mode, and one of receive an UL signal or channel on the first UL carrier, the UL signal or channel transmitted based on a first UL transmit power or receive the UL signal or channel on the second UL carrier, the UL signal or channel transmitted based on a second UL transmit power. The first and second information indicate a first UE maximum output power for an UL transmission bandwidth according to a first MPR value. The first MPR value is associated with a first transmission on the first UL carrier. The first and second information indicate a second UE maximum output power for an UL transmission bandwidth according to a second MPR value. The second MPR value is associated with a second transmission on the second UL carrier. The first UL transmit power and the second UL transmit power are based on the first and second UE maximum output powers, respectively.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example UE according to embodiments of the present disclosure;

FIGS. 4A and 4B illustrate an example of a wireless transmit and receive paths according to embodiments of the present disclosure;

FIG. 5 illustrates an example of a transmitter structure for beamforming according to embodiments of the present disclosure;

FIG. 6 illustrates an example of a transmitter structure for physical downlink shared channel (PDSCH) in a subframe according to embodiments of the present disclosure;

FIG. 7 illustrates an example of a receiver structure for PDSCH in a subframe according to embodiments of the present disclosure;

FIG. 8 illustrates an example of a transmitter structure for physical uplink shared channel (PUSCH) in a subframe according to embodiments of the present disclosure;

FIG. 9 illustrates an example of a receiver structure for a PUSCH in a subframe according to embodiments of the present disclosure;

FIG. 10 illustrates an example timeline of a separate P-MPR based mitigation behavior in a first and a second band of a band combination for a wireless communication system according to embodiments of the present disclosure;

FIG. 11 illustrates an example flowchart for a process of a separate P-MPR based mitigation behavior in a first and a second band of a band combination for a wireless communication system according to embodiments of the present disclosure;

FIG. 12 illustrates an example flowchart for a process of a joint/common P-MPR based mitigation behavior in a first and a second band of a band combination to determine an UL maximum output power for a wireless communication system according to embodiments of the present disclosure;

FIG. 13 illustrates an example flowchart for a process of a P-MPR based mitigation using an adjustment factor in a band combination for a wireless communication system according to embodiments of the present disclosure; and

FIG. 14 illustrates an example method performed by a UE in a wireless communication system according to embodiments of the present disclosure.

### DETAILED DESCRIPTION

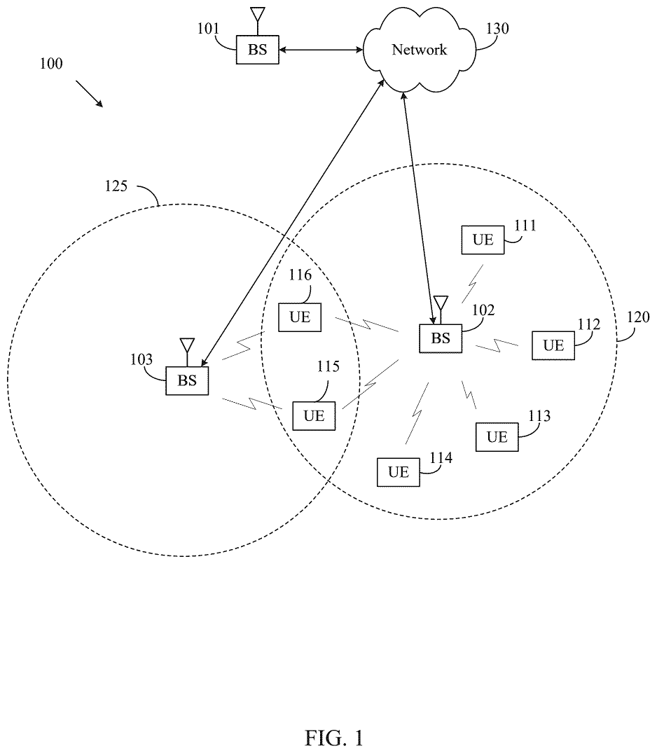

FIGS. 1-14 discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G/LTE communication systems, and to enable various vertical applications, 5G/NR communication systems have been developed and are currently being deployed. The 5G/NR communication system can be implemented in higher frequency (mmWave) bands, e.g., 23-39 GHz or 60 GHz bands, so as to accomplish higher data rates or in lower frequency bands, such as 3.7/3.8 GHz, to enable robust coverage and mobility support. 6th generation (6G) cellular communications is recently gathering increased momentum with all the worldwide technical activities on the various candidate technologies from industry and academia. The candidate enablers for the 6G communication system include massive antenna technologies, from legacy cellular frequency bands up to high frequencies, to provide beamforming gain and support increased capacity, waveform design to flexibly accommodate various services/applications with different requirements, new multiple access schemes to support massive connections, AI/ML, and so on

The discussion of 6G systems and frequency bands associated therewith is for reference as certain embodiments of the present disclosure may be implemented in 6G systems. However, the present disclosure is not limited to 6G systems, or the frequency bands associated therewith, and embodiments of the present disclosure may be utilized in connection with any frequency band. For example, aspects of the present disclosure may also be applied to deployment of 6G communication systems, to deployment of 5G/NR communication systems, to deployment of 4G/LTE communication systems, or even for deployments which may use terahertz (THz) bands in later releases.

The following documents are hereby incorporated by reference into the present disclosure as if fully set forth herein: 3GPP TS 38.211 v18.4.0, “NR; Physical channels and modulation” (REF1); 3GPP TS 38.212 v18.4.0, “NR; Multiplexing and Channel coding” (REF2); 3GPP TS 38.213 v18.4.0, “NR; Physical Layer Procedures for Control” (REF3); 3GPP TS 38.214 v18.4.0, “NR; Physical Layer Procedures for Data” (REF4); 3GPP TS 38.321 v18.3.0, “NR; Medium Access Control (MAC) protocol specification” (REF5); 3GPP TS 38.331 v18.3.0, “NR; Radio Resource Control (RRC) Protocol Specification” (REF6); 3GPP TS 38.101-1 v18.7.0, “NR; UE radio transmission and reception; Part 1: Range 1 Standalone” (REF7); 3GPP TS 38.101-2 v18.7.0, “NR; UE radio transmission and reception; Part 2: Range 2 Standalone” (REF8); 3GPP TS 38.101-3 v18.7.0, “NR; UE radio transmission and reception; Part 3: Range 1 and Range 2 Interworking operation with other radios” (REF9); 3GPP TS 38.133 v18.7.0, “NR; Requirements for support of radio resource management” (REF10); 3GPP TS 36.213 v18.2.0, “E-UTRA; Physical Layer Procedures” (REF11); 3GPP TS 38.300 v18.3.0, “NR and NG-RAN Overall Description (Stage 2)” (REF12); and 3GPP TS 37.340 v18.3.0, “E-UTRA and NR; Multi-connectivity; Overall Description (Stage 2)” (REF13).

Various of the figures and discussion below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of the present disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 6G, 5G/new radio (NR), 4G/long term evolution (LTE) or long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a 6G base station, a macrocell, a femtocell, a WiFi access point (AP), or other wirelessly enabled devices. Base stations may provide wireless access in accordance with one or more wireless communication protocols, e.g., 6G, 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or a vending machine or a fixed wireless access node).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for power reduction in wireless communication systems. In certain embodiments, one or more of the BSs 101-103 include circuitry, programing, or a combination thereof to support power reduction in wireless communication systems. Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

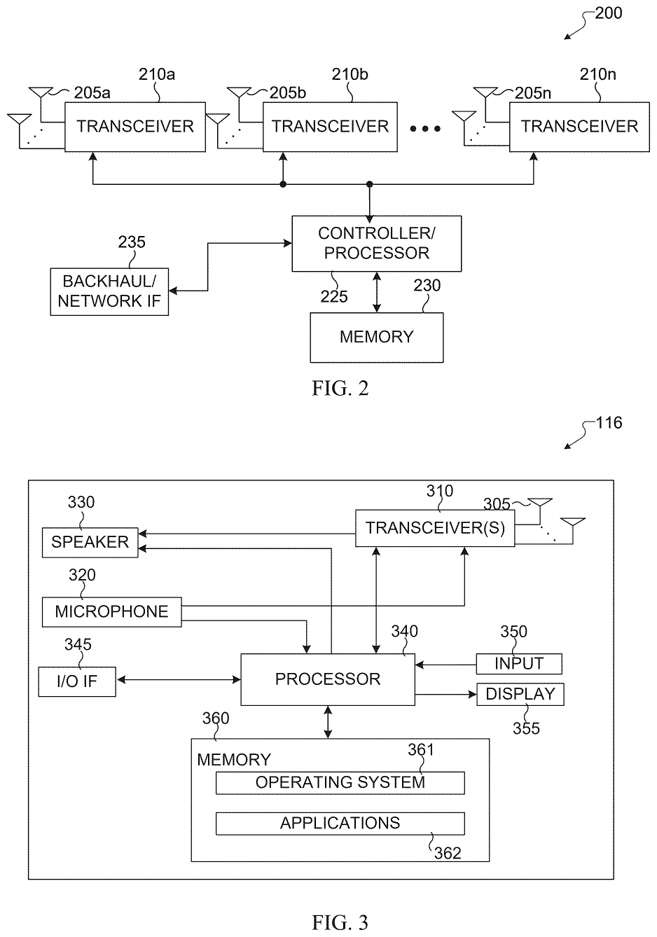

FIG. 2 illustrates an example TRP 200 according to embodiments of the present disclosure. For example, the TRP 200 any be a base station, such as gNB 101-103, or may be an NCR or smart repeater (SR). The embodiment of the TRP 200 illustrated in FIG. 2 is for illustration only. However, TRPs come in a wide variety of configurations, and FIG. 2 does not limit the scope of the present disclosure to any particular implementation of a TRP.

As shown in FIG. 2, the TRP 200 includes multiple antennas 205a-205n, multiple transceivers 210a-210n, a controller/processor 225, a memory 230, and a backhaul or network interface 235. The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

For example, in embodiments where the TRP is a repeater, one or more of the transceivers 210 may be used for an NCR-RU entity or NCR-Fwd entity as a DL connection for signaling over an access link with a UE and/or over a backhaul link with a gNB. In these examples, the associated one(s) of the transceivers 210 for the NCR-RU entity or NCR-Fwd entity may not covert the incoming RF signal to IF or a baseband signal but rather amplify the incoming RF signal and forward or relay the amplified signal, without any down conversion to IF or baseband. In another example, in embodiments where the TRP is a repeater, one or more of the transceivers 210 may be used for an NCR-MT entity as a DL or UL connection for control signaling over a control link (C-link) with a gNB.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the TRP 200. For example, the controller/processor 225 could control the reception of UL channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for power reduction in wireless communication systems. Any of a wide variety of other functions could be supported in the TRP 200 by the controller/processor 225.

The controller/processor 225 is also capable of executing programs and other processes resident in the memory 230, such as processes to support transmission power in a wireless communication system. The controller/processor 225 can move data into or out of the memory 230 as required by an executing process.

The controller/processor 225 is also coupled to the backhaul or network interface 235. The backhaul or network interface 235 allows the TRP 200 to communicate with other devices or systems over a backhaul connection or over a network. The interface 235 could support communications over any suitable wired or wireless connection(s). For example, when the TRP 200 is implemented as part of a cellular communication system (such as one supporting 6G, 5G/NR, LTE, or LTE-A), the interface 235 could allow the TRP 200 to communicate with other gNBs over a wired or wireless backhaul connection, for example, using a transceiver, such as described above with regard to transceivers 210. For example, in embodiments where the TRP is a repeater, the interface 235 may be used for an NCR-RU or NCR-Fwd entity as a backhaul connection with a gNB over a backhaul link for control signaling and/or data to be transmitted to and/or received from a UE. When the TRP 200 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of TRP 200, various changes may be made to FIG. 2. For example, the TRP 200 could include any number of each component shown in FIG. 2. Also, various components in FIG. 2 could be combined, further subdivided, or omitted and additional components could be added according to particular needs.

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of the present disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for power reduction in wireless communication systems as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites. The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

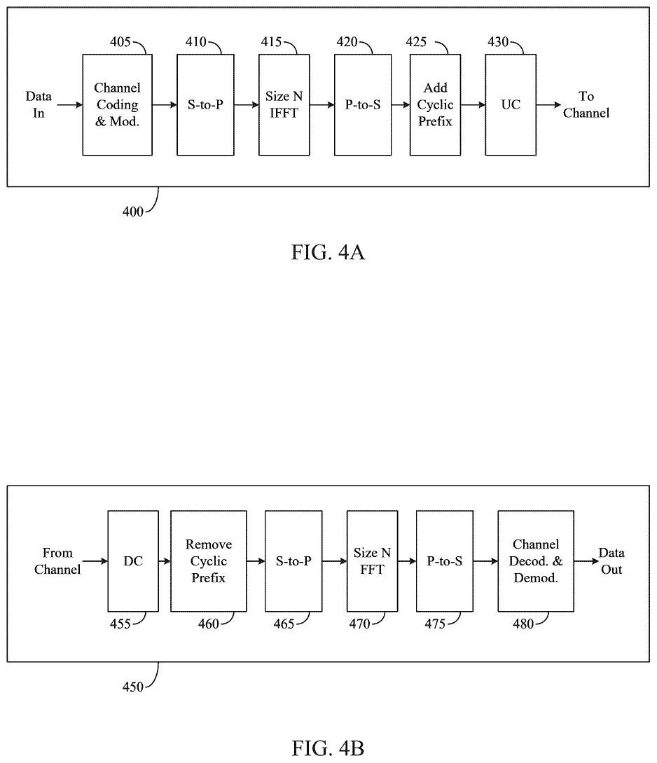

FIG. 4A and FIG. 4B illustrate an example of wireless transmit and receive paths 400 and 450, respectively, according to embodiments of the present disclosure. For example, a transmit path 400 may be described as being implemented in a gNB or TRP (such as gNB 102 or TRP 200), while a receive path 450 may be described as being implemented in a UE (such as UE 116). However, it will be understood that the receive path 450 can be implemented in a gNB or TRP and that the transmit path 400 can be implemented in a UE. In some embodiments, the transmit path 400 and/or the receive path 450 is configured for operation in a 6G or 5G/NR or 4G/LTE in a wireless communication system as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB and the UE. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 or the TRP 200 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 or the TRP 200 and may implement a receive path 450 for receiving in the downlink from gNBs 101-103 or the TRP 200.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of the present disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted, and additional components can be added according to particular needs. Also, FIGS. 4A and 4B are meant to illustrate examples of the types of transmit and receive paths that can be used in a wireless network. Any other suitable architectures can be used to support wireless communications in a wireless network.

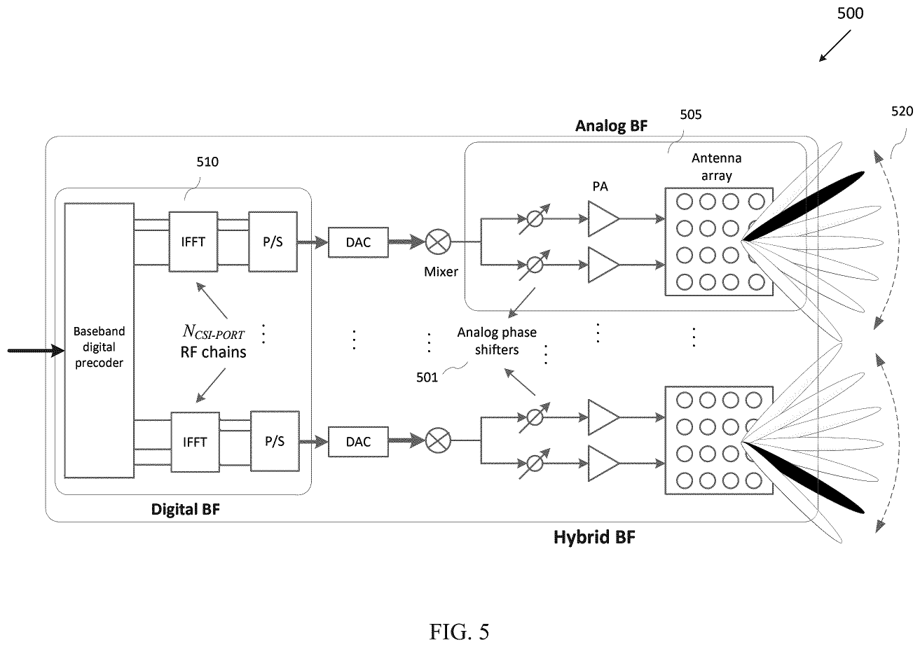

FIG. 5 illustrates an example of a transmitter structure 500 for beamforming according to embodiments of the present disclosure. In certain embodiments, one or more of gNB 102 or UE 116 includes the transmitter structure 500. For example, one or more of antenna 205 and its associated systems or antenna 305 and its associated systems can be included in transmitter structure 500. This example is for illustration only and other embodiments can be used without departing from the scope of the present disclosure.

Accordingly, embodiments of the present disclosure recognize that Rel-14 LTE and Rel-15 NR support up to 32 CSI reference signal (CSI-RS) antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 5. Then, one CSI-RS port can be mapped onto a large number of antenna elements that can be controlled by a bank of analog phase shifters 501. One CSI-RS port can then correspond to one sub-array which produces a narrow analog beam through analog beamforming 505. This analog beam can be configured to sweep across a wider range of angles 520 by varying the phase shifter bank across symbols or slots/subframes. The number of sub-arrays (equal to the number of RF chains) is the same as the number of CSI-RS ports N_{CSI-PORT}. A digital beamforming unit 510 performs a linear combination across N_{CSI-PORT} analog beams to further increase a precoding gain. While analog beams are wideband (hence not frequency-selective), digital precoding can be varied across frequency sub-bands or resource blocks. Receiver operation can be conceived analogously.

Since the transmitter structure 500 of FIG. 5 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 5 is also applicable to higher frequency bands such as >52.6 GHz (also termed frequency range 4 or FR4). In this case, the system can employ only analog beams. Due to the O2 absorption loss around 60 GHz frequency (˜10 dB additional loss per 100 m distance), a larger number and narrower analog beams (hence a larger number of radiators in the array) are essential to compensate for the additional path loss.

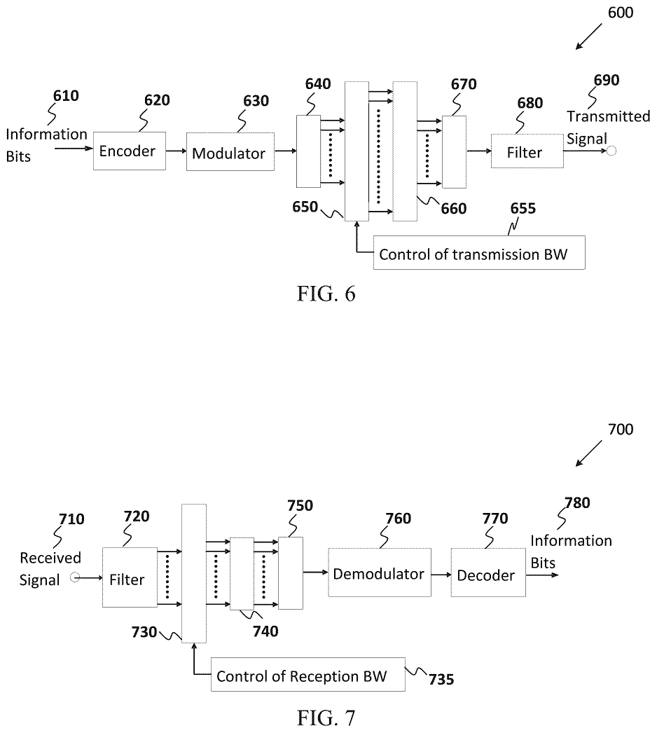

FIG. 6 illustrates an example of a transmitter structure 600 for PDSCH in a subframe according to embodiments of the present disclosure. For example, transmitter structure 600 can be implemented in gNB 102 of FIG. 1. This example is for illustration only and other embodiments can be used without departing from the scope of the present disclosure.

As illustrated in FIG. 6, information bits 610 are encoded by encoder 620, such as a turbo encoder, and modulated by modulator 630, for example using Quadrature Phase Shift Keying (QPSK) modulation. A Serial to Parallel (S/P) converter 640 generates M modulation symbols that are subsequently provided to a mapper 650 to be mapped to REs selected by a transmission BW selection unit 655 for an assigned PDSCH transmission BW, unit 660 applies an Inverse Fast Fourier Transform (IFFT), the output is then serialized by a Parallel to Serial (P/S) converter 670 to create a time domain signal, filtering is applied by filter 680, and a signal transmitted 690. Additional functionalities, such as data scrambling, cyclic prefix insertion, time windowing, interleaving, and others are well known in the art and are not shown for brevity.

FIG. 7 illustrates an example of a receiver structure 700 for PDSCH in a subframe according to embodiments of the present disclosure. For example, receiver structure 700 can be implemented by any of the UEs 111-116 of FIG. 1. This example is for illustration only and other embodiments can be used without departing from the scope of the present disclosure.

With reference to FIG. 7, a received signal 710 is filtered by filter 720, REs 730 for an assigned reception BW are selected by BW selector 735, unit 740 applies a Fast Fourier Transform (FFT), and an output is serialized by a parallel-to-serial converter 750. Subsequently, a demodulator 760 coherently demodulates data symbols by applying a channel estimate obtained from a demodulation reference signal (DMRS) or a CRS (not shown), and a decoder 770, such as a turbo decoder or a low-density-parity-check (LDPC) decoder, decodes the demodulated data to provide an estimate of the information data bits 780. Additional functionalities such as time-windowing, cyclic prefix removal, de-scrambling, channel estimation, and de-interleaving are not shown for brevity.

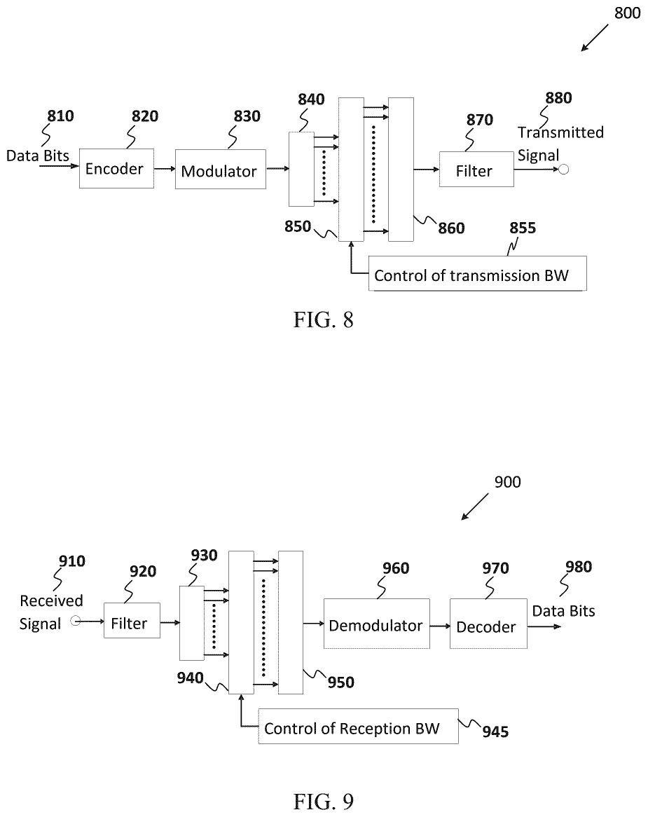

FIG. 8 illustrates an example of a transmitter structure 800 for PUSCH in a subframe according to embodiments of the present disclosure. For example, transmitter structure 800 can be implemented in gNB 103 of FIG. 1. This example is for illustration only and other embodiments can be used without departing from the scope of the present disclosure.

As illustrated in FIG. 8, information data bits 810 are encoded by encoder 820, such as a turbo encoder, and modulated by modulator 830. A Discrete Fourier Transform (DFT) unit 840 applies a DFT on the modulated data bits, REs 850 corresponding to an assigned PUSCH transmission BW are selected by transmission BW selection unit 855, unit 860 applies an IFFT and, after a cyclic prefix insertion (not shown), filtering is applied by filter 870 and a signal transmitted 880.

FIG. 9 illustrates an example of a receiver structure 900 for a PUSCH in a subframe according to embodiments of the present disclosure; For example, receiver structure 900 can be implemented by the UE 116 of FIG. 3. This example is for illustration only and other embodiments can be used without departing from the scope of the present disclosure.

As illustrated in FIG. 9, a received signal 910 is filtered by filter 920. Subsequently, after a cyclic prefix is removed (not shown), unit 930 applies a FFT, REs 940 corresponding to an assigned PUSCH reception BW are selected by a reception BW selector 945, unit 950 applies an Inverse DFT (IDFT), a demodulator 960 coherently demodulates data symbols by applying a channel estimate obtained from a DMRS (not shown), a decoder 970, such as a turbo decoder or a low-density-parity-check (LDPC) decoder, decodes the demodulated data to provide an estimate of the information data bits 980.

A communication system can include a downlink (DL) that refers to transmissions from a base station (such as the BS 102) or one or more transmission points to UEs (such as the UE 116) and an UL that refers to transmissions from UEs (such as the UE 116) to a base station (such as the BS 102) or to one or more reception points.

A time unit for DL signaling or for UL signaling on a cell is referred to as a slot and can include one or more symbols. A symbol can also serve as an additional time unit. A frequency or bandwidth (BW) unit is referred to as a resource block (RB). One RB includes a number of sub-carriers (SCs). For example, a slot can have duration of 1 millisecond or 0.5 millisecond, include 14 symbols and an RB can include 12 SCs with inter-SC spacing of 15 kHz or 30 kHz, and so on.

DL signals include data signals conveying information content, control signals conveying DL control information (DCI), and reference signals (RS) that are also known as pilot signals. A gNB transmits data information or DCI through respective physical DL shared channels (PDSCHs) or physical DL control channels (PDCCHs). A PDSCH or a PDCCH can be transmitted over a variable number of slot symbols including one slot symbol. For brevity, a DCI format scheduling a PDSCH reception by a UE is referred to as a DL DCI format and a DCI format scheduling a physical uplink shared channel (PUSCH) transmission from a UE is referred to as an UL DCI format. A DCI format scheduling PDSCH reception or PUSCH transmission for a single UE, such as a DCI format with cyclic redundancy check (CRC) scrambled by cell-radio network temporary identifier (C-RNTI/configured scheduling RNTI (CS-RNTI)/modulation and coding scheme (MCS)-C-RNTI as described in REF2, are referred for brevity as a unicast DCI format. A DCI format scheduling PDSCH reception for multicast communication, such as a DCI format with CRC scrambled by group (G)-RNTI/G-CS-RNTI as described in REF2, are referred to as multicast DCI format. DCI formats providing various control information to at least a subset of UEs in a serving cell, such as DCI format 2_0 in REF2, are referred to as group-common (GC) DCI formats.

A gNB (such as the BS 102) transmits one or more of multiple types of RS including channel state information RS (CSI-RS) and demodulation RS (DM-RS). A CSI-RS is primarily intended for UEs to perform measurements and provide channel state information (CSI) to a gNB. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used. A CSI process includes NZP CSI-RS and CSI-IM resources.

A UE (such as the UE 116) can determine CSI-RS transmission parameters through DL control signaling or higher layer signaling, such as radio resource control (RRC) signaling, from a gNB (such as the BS 102). Transmission instances of a CSI-RS can be indicated by DL control signaling or be configured by higher layer signaling. A DM-RS is transmitted only in the BW of a respective PDCCH or PDSCH and a UE can use the DM-RS to demodulate data or control information.

In certain embodiments, UL signals also include data signals conveying information content, control signals conveying UL control information (UCI), DM-RS associated with data or UCI demodulation, sounding RS (SRS) enabling a gNB to perform UL channel measurement, and a RA preamble enabling a UE to perform RA. A UE transmits data information or UCI through a respective PUSCH or a physical UL control channel (PUCCH). A PUSCH or a PUCCH can be transmitted over a variable number of slot symbols including one slot symbol. The gNB can configure the UE to transmit signals on a cell within an active UL bandwidth part (BWP) of the cell UL BW.

UCI includes hybrid automatic repeat request (HARQ) acknowledgement (ACK) information, indicating correct or incorrect detection of data transport blocks (TBs) in a PDSCH, scheduling request (SR) indicating whether a UE has data in a buffer, and CSI reports enabling a gNB to select appropriate parameters for PDSCH or PDCCH transmissions to a UE. HARQ-ACK information can be configured to be with a smaller granularity than per TB and can be per data code block (CB) or per group of data CBs where a data TB includes a number of data CBs.

A CSI report from a UE can include a channel quality indicator (CQI) informing a gNB of a largest modulation and coding scheme (MCS) for the UE to detect a data TB with a predetermined block error rate (BLER), such as a 10% BLER, of a precoding matrix indicator (PMI) informing a gNB how to combine signals from multiple transmitter antennas in accordance with a MIMO transmission principle, and of a rank indicator (RI) indicating a transmission rank for a PDSCH.

UL RS includes DM-RS and SRS. DM-RS is transmitted only in a BW of a respective PUSCH or PUCCH transmission. A gNB can use a DM-RS to demodulate information in a respective PUSCH or PUCCH. SRS is transmitted by a UE to provide a gNB with an UL CSI and, for a TDD system, an SRS transmission can also provide a PMI for DL transmission. Additionally, in order to establish synchronization or an initial higher layer connection with a gNB, a UE can transmit a physical random-access channel (PRACH as shown in NR specifications).

An antenna port is defined such that the channel over which a symbol on the antenna port is conveyed can be inferred from the channel over which another symbol on the same antenna port is conveyed.

For DM-RS associated with a PDSCH, the channel over which a PDSCH symbol on one antenna port is conveyed can be inferred from the channel over which a DM-RS symbol on the same antenna port is conveyed only if the two symbols are within the same resource as the scheduled PDSCH, in the same slot, and in the same precoding resource block group (PRG).

For DM-RS associated with a PDCCH, the channel over which a PDCCH symbol on one antenna port is conveyed can be inferred from the channel over which a DM-RS symbol on the same antenna port is conveyed only if the two symbols are within resources for which the UE may assume the same precoding being used.

For DM-RS associated with a physical broadcast channel (PBCH), the channel over which a PBCH symbol on one antenna port is conveyed can be inferred from the channel over which a DM-RS symbol on the same antenna port is conveyed only if the two symbols are within a synchronization signal/physical broadcast channel (SS/PBCH) block transmitted within the same slot, and with the same block index.

Two antenna ports are said to be quasi co-located if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial Rx parameters.

The UE (such as the UE 116) may assume that synchronization signal (SS)/PBCH block (also denoted as synchronization signal blocks (SSBs)) transmitted with the same block index on the same center frequency location are quasi co-located with respect to Doppler spread, Doppler shift, average gain, average delay, delay spread, and, when applicable, spatial Rx parameters. The UE may not assume quasi co-location for any other synchronization signal SS/PBCH block transmissions.

In absence of CSI-RS configuration, and unless otherwise configured, the UE may assume PDSCH DM-RS and SSB to be quasi co-located with respect to Doppler shift, Doppler spread, average delay, delay spread, and, when applicable, spatial Rx parameters. The UE may assume that the PDSCH DM-RS within the same code division multiplexing (CDM) group is quasi co-located with respect to Doppler shift, Doppler spread, average delay, delay spread, and spatial Rx. The UE may also assume that DM-RS ports associated with a PDSCH are quasi co-location (QCL) with QCL type A, type D (when applicable) and average gain. The UE may further assume that no DM-RS collides with the SS/PBCH block.

A beam may be determined by a transmission configuration indication (TCI) state that establishes a quasi-co-location (QCL) relationship or a spatial relation between a source reference signal, e.g., a synchronization signal block (SS/PBCH Block or SSB) or channel state information reference signal (CSI-RS) and a target reference signal, or a spatial relationship information that establishes an association to a source reference signal, such as an SSB, CSI-RS, or sounding reference signal (SRS). In either case, the ID of the source reference signal can identify the beam.

The TCI state and/or the spatial relationship reference RS can determine a spatial Rx filter for reception of downlink channels or signals at the UE, or a spatial Tx filter for transmission of uplink channels or signals from the UE. The TCI state and/or the spatial relation reference RS can determine a spatial Tx filter for transmission of downlink channels or signals from the gNB, or a spatial Rx filter for reception of uplink channels or signals at the gNB.

A UE can be indicated a spatial setting for a PDCCH reception based on a configuration of a value for a transmission configuration indication state (TCI state) of a control resource set (CORESET) where the UE receives the PDCCH. The UE can be indicated a spatial setting for a PDSCH reception based on a configuration by higher layers or based on an indication by a DCI format scheduling the PDSCH reception of a value for a TCI state. The gNB can configure the UE to receive signals on a cell within a DL bandwidth part (BWP) of the cell DL BW.

The UE can be configured with a list of up to M transmission configuration indication (TCI) State configurations within the higher layer parameter PDSCH-Config to decode PDSCH according to a detected PDCCH with DCI intended for the UE and the given serving cell, where M depends on the UE capability maxNumberConfiguredTCIstatesPerCC. Each TCI-State contains parameters for configuring a quasi-colocation (QCL) relationship between one or two downlink reference signals and the DM-RS ports of the PDSCH, the DM-RS port of PDCCH or the CSI-RS port(s) of a CSI-RS resource.

A quasi-co-location (QCL) relationship may be configured by the higher layer parameter qcl-Type1 for a first DL RS, and qcl-Type2 for a second DL RS (if configured). For the case of two DL RSs, the QCL types may not be the same, regardless of whether the references are to the same DL RS or different DL RSs. The quasi-co-location types corresponding to each DL RS can be given by the higher layer parameter qcl-Type in QCL-Info and may take one of the following values: QCL-TypeA: {Doppler shift, Doppler spread, average delay, delay spread}; QCL-TypeB: {Doppler shift, Doppler spread; QCL-TypeC: {Doppler shift, average delay}; and QCL-TypeD: {Spatial Rx parameter}.

A reference RS may correspond to a set of characteristics of a DL beam or an UL Tx beam, such as a direction, a precoding/beamforming, a number of ports, and so on.

A UE can be provided through higher layer RRC signaling a set of TCI States with N elements. In one example, DL and joint TCI states are configured by higher layer parameter DLorJoint-TCIState, wherein, the number of DL and Joint TCI state is N_{DJ}. UL TCI states are configured by higher layer parameter UL-TCIState, wherein the number of UL TCI states is N_{U}. N=N_{DJ}+N_{U}. The DLorJoint-TCIState can include DL or Joint TCI states for a serving cell. The source RS of the TCI state may be associated with the serving cell, e.g., the physical cell ID (PCI) of the serving cell. Additionally, the DL or Joint TCI states can be associated with a cell having a PCI different from the PCI of the serving cell, e.g., the source RS of the TCI state is associated with a cell having a PCI different from the PCI of the serving cell. The UL-TCIState can include UL TCI states that belong to a serving cell, e.g., the source RS of the TCI state is associated with the serving cell (the PCI of the serving cell); additionally, the UL TCI states can be associated with a cell having a PCI different from the PCI of the serving cell, e.g., the source RS of the TCI state is associated with a cell having a PCI different from the PCI of the serving cell.

MAC CE signaling can include a subset of M (M≤N) TCI states or TCI state code points from the set of N TCI states, wherein a code point is signaled in the “transmission configuration indication” field of a DCI used for indication of the TCI state. A codepoint can include one TCI state, e.g., DL TCI state or UL TCI state or Joint (DL and UL) TCI state. Alternatively, a codepoint can include two TCI states, e.g., a DL TCI state and an UL TCI state. L1 control signaling, i.e., Downlink Control Information (DCI) can update the UE's TCI state, wherein the DCI includes a “transmission configuration indication” (beam indication) field, e.g., using m bits such that M≤2^{m}. The TCI state may correspond to a code point signaled by MAC CE. A DCI used for indication of the TCI state can be a DCI format 1_1 or DCI format 1_2 or DCI format 1_3 with a DL assignment for PDSCH receptions or without a DL assignment for PDSCH receptions.

The TCI states can be associated through a QCL relation with an SSB or a CSI-RS of serving cell, or an SSB or a CSI-RS associated with a PCI different from the PCI of the serving cell. The QCL relation with an SSB can be a direct QCL relation, wherein the source RS, e.g., for a QCL Type D relation or a spatial relation of the QCL state is the SSB. The QCL relation with an SSB can be an indirect QCL relation wherein the source RS, e.g., for a QCL Type D relation or a spatial relation can be a CSI-RS, and the CSI-RS has the SSB as its source, e.g., for a QCL Type D relation or a spatial relation. The indirect QCL relation to an SSB can involve a QCL or spatial relation chain of more than one CSI-RS.

In the present disclosure, the frequency resolution (reporting granularity) and span (reporting bandwidth) of CSI or calibration coefficient reporting can be defined in terms of frequency “subbands” and “CSI reporting band” (CRB), respectively.

A subband for CSI or calibration coefficient reporting is defined as a set of contiguous physical resource blocks (PRBs) which represents the smallest frequency unit for CSI or calibration coefficient reporting. The number of PRBs in a subband can be fixed for a given value of DL system bandwidth, configured either semi-statically via higher layer/RRC signaling, or dynamically via L1 DL control signaling or MAC control element (MAC CE). The number of PRBs in a subband can be included in CSI or calibration coefficient reporting setting. The term “CSI reporting band” is defined as a set/collection of subbands, either contiguous or non-contiguous, wherein CSI or calibration coefficient reporting is performed. For example, CSI or calibration coefficient reporting band can include the subbands within the DL system bandwidth. This can also be termed “full-band”. Alternatively, CSI or calibration coefficient reporting band can include only a collection of subbands within the DL system bandwidth. This can also be termed “partial band”. The term “CSI reporting band” is used only as an example for representing a function. Other terms such as “CSI reporting subband set” or “CSI or calibration coefficient reporting bandwidth” can also be used.

In terms of UE configuration, a UE can be configured with at least one CSI or calibration coefficient reporting band. This configuration can be semi-static (via higher layer signaling or RRC) or dynamic (via MAC CE or L1 DL control signaling). When configured with multiple (N) CSI or calibration coefficient reporting bands (e.g., via RRC signaling), a UE can report CSI associated with n≤N CSI reporting bands. For instance, >6 GHz, large system bandwidth may require multiple CSI or calibration coefficient reporting bands. The value of n can either be configured semi-statically (via higher layer signaling or RRC) or dynamically (via MAC CE or L1 DL control signaling). Alternatively, the UE can report a recommended value of n via an UL channel.

Therefore, CSI parameter frequency granularity can be defined per CSI reporting band as follows. A CSI parameter is configured with “single” reporting for the CSI reporting band with Mn subbands when one CSI parameter for the Mₙ subbands within the CSI reporting band. A CSI parameter is configured with “subband” for the CSI reporting band with Mn subbands when one CSI parameter is reported for each of the Mn subbands within the CSI reporting band.

In the following and throughout the disclosure, various embodiments of the disclosure may be also implemented in any type of UE including, for example, a 6G UE, or a UEs with the same, similar, or more capabilities compared to a Rel-21 6G or a 5G/NR UEs. Although various embodiments of the disclosure discuss 3GPP 6G 5G/NR wireless communication systems, the embodiments may apply in general to UEs operating with other RATs and/or standards, such as next releases/generations of 3GPP, IEEE Wi-Fi, and so on.

The term ‘activation’ describes an operation wherein a UE receives and decodes a signal from the network (or gNB) that signifies a starting point in time. The starting point can be a present or a future slot/subframe or symbol and the exact location is either implicitly or explicitly indicated, or is otherwise specified in the system operation or is configured by higher layers. Upon successfully decoding the signal, the UE responds according to an indication provided by the signal. The term “deactivation” describes an operation wherein a UE receives and decodes a signal from the network (or gNB) that signifies a stopping point in time. The stopping point can be a present or a future slot/subframe or symbol and the exact location is either implicitly or explicitly indicated, or is otherwise specified in the system operation or is configured by higher layers. Upon successfully decoding the signal, the UE responds according to an indication provided by the signal.

In the following, unless otherwise explicitly noted, providing a parameter value by higher layers includes providing the parameter value by a system information block (SIB), such as a SIB1, or by a common RRC signaling, or by UE-specific RRC signaling, or by core network signaling between a UE and a network node.

In the following, the suffix ‘-rxx’ is used to denote a parameter that does not currently exist in specifications and can be introduced to support the disclosed functionalities, with ‘xx’ denoting a number of a 3GPP release for the introduction of the parameter, e.g., xx=20 for Rel-20, or xx=21 for Rel-21, etc.

In the following, for brevity of description, the higher layer provided TDD UL-DL frame configuration refers to tdd-UL-DL-ConfigurationCommon as example for RRC common configuration and/or tdd-UL-DL-ConfigurationDedicated as example for UE-specific configuration. The UE determines a common TDD UL-DL frame configuration of a serving cell by receiving a SIB such as a SIB1 when accessing the cell from RRC_IDLE or by RRC signaling when the UE is configured with an SCell or additional SCGs by an IE ServingCellConfigCommon in RRC_CONNECTED. The UE determines a dedicated TDD UL-DL frame configuration using the IE ServingCellConfig when the UE is configured with a serving cell, e.g., add or modify, where the serving cell may be the SpCell or an SCell of an MCG or SCG. A TDD UL-DL frame configuration designates a slot or symbol as one of types ‘D’, ‘U’ or ‘F’ using at least one time-domain pattern with configurable periodicity.

Terminology such as TCI, TCI states, SpatialRelationInfo, target RS, reference RS, and other terms is used for illustrative purposes and is therefore not normative. Other terms that refer to same functions can also be used. A “reference RS” corresponds to a set of characteristics of a DL RX beam or an UL TX beam, such as a direction, a precoding/beamforming, a number of ports, and so on. A beam may also be referred to as spatial filter or spatial setting and be associated with a TCI state for quasi co-location (QCL) properties.

In certain embodiments, a TCI state may be used for beam indication. A TCI state may refer to a DL TCI state for DL channels, e.g. PDCCH or PDSCH, an UL TCI state for UL channels, e.g. PUSCH or PUCCH, a joint TCI state for DL and UL channels, or separate TCI states for UL and DL channels or signals. A TCI state may be common across multiple component carriers or may be a separate TCI state for a component carrier of a set of component carriers. A TCI state may be gNB or UE panel specific or common across panels. In some examples, an UL TCI state may be replaced by an SRS resource indicator (SRI).

In certain embodiments, a cell may include more than one transmission/reception point (TRP). For example, mTRP operation may be referred to as intra-cell mTRP operation. In one example, a TRP may be identified by a CORESETPoolIndex associated with CORESETs for PDCCH receptions. In one example, a TRP may be identified by a group (e.g., one or more) SS/PBCH blocks (SSBs). For example, a first group or set of SSBs belong to or determine or identify a first TRP, a second group or set of SSBs belong to or determine or identify a second TRP, and so on. In one example, a TRP may be identified by a group (e.g., one or more) channel state information reference signal (CSI-RS) resources or CSI-RS resource sets. For example, a first group or set of CSI-RS resources or CSI-RS resource sets belong to or determine or identify a first TRP, a second group or set of CSI-RS resources or CSI-RS resource sets belong to determine or identify a second TRP, and so on. In one example, a TRP may be identified by a group (e.g., one or more) antenna ports. For example, a first group or set of antenna ports belong to or determine or identify a first TRP, a second group or set of antenna ports belong to determine or identify a second TRP, and so on. In one example, a TRP is identified or determined following one or more of the previous examples. In one example, a TRP may be identified by a group (e.g., one or more) sounding reference signal (SRS) resources or SRS resource sets. For example, a first group or set of SRS resources or SRS resource sets belong to or determine or identify a first TRP, a second group or set of SRS resources or SRS resource sets belong to or determine or identify a second TRP, and so on. In one example, a TRP may be identified by a group (e.g., one or more) TCI states (UL TCI states or DL TCI states or Joint TCI states or TCI state codepoints). For example, a first group or set of TCI states belong to or determine or identify a first TRP, a second group or set of TCI states belong to or determine or identify a second TRP, and so on.

In certain embodiments, the term “FR1” or a frequency range designation “FR1” may refer to a corresponding frequency range 410-7125 MHz; the term “FR2-1” or a frequency range designation “FR2-1” may refer to a corresponding frequency range 24250-52600 MHz; the term “FR2-2” or a frequency range designation “FR2-2” may refer to a corresponding frequency range 52600-71000 MHz; the term “FR2” or a frequency-range designation “FR2” may refer to FR2-1 or FR2-2.

In certain embodiments, the term “FR3” or a frequency range designation “FR3” may refer to a corresponding frequency range 7125-24250 MHz, or parts thereof. For example, an FR3 band may correspond to 7125-8400 MHz, or parts thereof, in ITU Region 2 or ITU Region 3. For example, an FR3 band may correspond to 7125-7250 MHz or 7750-8400 MHz, or parts thereof, in ITU Region 1. For example, an FR3 band may correspond to 14800-15350 MHz, or parts thereof, in an ITU Region. For example, for simplicity and illustration purposes, the term “FR3 7-8 GHz” may be used to refer to 6G radio access on a carrier or in a band of a frequency range such as 7125-8400 MHz, or the term “FR3 14-15 GHz” may be used to refer to 6G radio access on a carrier or in a band of a frequency range such as 14800-15350 MHz. The term “FR3 7-8 GHz” may be used interchangeably with a term such as “FR3 band 7-8 GHz” or “6G band 7-8 GHz”. For example, a lower frequency range of FR3 may also be classified as part of FR1.

In certain embodiments, 6G radio access may be supported on a carrier or in a band of a frequency range such as FR1 corresponding to 4400-4800 MHz, or in a carrier or in a band corresponding to an FR1 or an FR2 operating band as defined in REFS7-9. For example, the term “FR1 4 GHz” may be used interchangeably with a term such as “FR1 band 4 GHz” or “6G band 4 GHz”.

In certain embodiments, 5G/NR or 4G/LTE radio access may be supported on a carrier or in a band of a frequency range corresponding to an FR1 operating band, or 5G/NR radio access may be supported on a carrier or in a band of an FR2 operating band such as defined in REFS7-9 for 5G/NR.

In certain embodiments, a UE supporting 6G radio access may operate in single RAT mode or may operate in dual RAT mode.

For example, when operating in single RAT mode, the UE may select one RAT, e.g., one of 4G/LTE or 5G/NR or 6G radio access to (re-)select and camp on a serving cell in a band when in RRC_IDLE or RRC_INACTIVE state. For example, when operating in single RAT mode, the UE may be indicted one or more serving cells corresponding to one RAT in one or more bands by the network using mobility or handover procedures when in RRC_CONNECTED state. For example, a UE supporting 6G radio access and operating in single RAT mode may also support 4G/LTE or 5G/NR radio access or may also support other wireless radio access such as Wi-Fi or Bluetooth or UWB.

For example, a dual RAT mode may be based on carrier aggregation operation, or dual connectivity operation or dual active protocol stack operation. For example, when operating in dual RAT mode, a multiple Rx and/or multiple Tx capable UE may be concurrently or simultaneously active on two serving cells using a separate RAT for each serving cell, respectively, wherein a first RAT may correspond to 6G radio access, and a second RAT corresponds to one of 5G/NR radio access or 4G/LTE radio access. For example, when operating in dual RAT mode, the UE may be indicated with a first cell group comprising one or more serving cells corresponding to the first RAT, and a second cell group comprising one or more serving cells corresponding to the second RAT. For example, the first cell group may correspond to an MCG, and the second cell group may correspond to an SCG with reference to carrier aggregation or dual connectivity. Serving cells or cell groups may be located in a same or in different bands. For example, a UE supporting 6G radio access and operating in dual RAT mode may also support 4G/LTE or 5G/NR radio access or may also support other wireless radio access.

For example, when operating in dual RAT mode based on principles such as described in REF11 for multi-RAT dual-connectivity operation for scenarios such as LTE-NR or NR-LTE or NR-NR, a UE supporting 6G radio access may be configured to utilize radio resources provided by two different nodes connected via non-ideal or ideal backhaul, one node providing 6G radio access and the other node providing either 4G/LTE or 5G/NR radio access. One node may act as a master node (MN) and the other as secondary node (SN), where the MN and SN are connected via a network interface and at least the MN is connected to the core network. Transmissions to the UE or receptions from the UE using 4G/LTE or 5G/NR radio access may then occur on a primary cell group (PCG), and transmissions to the UE or receptions from the UE using 6G radio access may then occur on a secondary cell group (SCG). In another example, 6G radio access may occur on the PCG and 4G/LTE or 5G/NR radio access may occur on the SCG. For example, when operating in dual RAT mode based on carrier aggregation, if supported by 6G radio access, the UE supporting 6G radio access may be scheduled per cell group and network-side scheduling between the first and the second cell group, respectively, may or may not be coordinated between the cell groups.

For example, when operating in dual RAT mode based on dual active protocol stack operation, the UE supporting 6G radio access may be connected to a 6G serving cell in a first band while being connected to a 4G/LTE or 5G/NR cell in a second band. In one example, a dual-active protocol stack UE maintains separate RRC states with respect to the radio access network, i.e., a first RRC state corresponding to the 6G radio access and a second RRC state corresponding to the 5G/NR or the 4G/LTE radio access. In one example, a dual-active protocol stack UE may maintain a same or separate mobility or connection states with respect to the core network, i.e., a first mobility or connection management state corresponding to the 6G radio access and a second mobility or connection state corresponding to the 5G/NR or the 4G/LTE radio access.

In certain embodiments, a UE supporting 6G radio access may transmit or receive on a carrier or in a band of a band combination according to carrier aggregation operation, or according to dual connectivity operation, or according to dual active protocol stack operation. Without loss of generality and for conciseness of description, the term “band combination” may refer to a band combination such as defined with respect to a carrier-aggregation band combination, or such as a dual connectivity band combination, or such as a dual active protocol stack band combination. For example, a UE supporting 6G radio access may operate in FDD mode or in TDD mode on a carrier or in a band. For example, the UE supporting 6G radio access may operate in a combination of FDD and/or TDD modes in a band or in a band combination.

In certain embodiments, the UE supporting 6G radio access may transmit or receive on a carrier or in a band of a band combination according to carrier aggregation operation, or according to dual connectivity operation, or according to dual active protocol stack operation using a single UL carrier or using two or more UL contiguous or non-contiguous carriers. For example, based on single UL carrier operation, the UE supporting 6G radio access may transmit an UL signal or channel in a first UL carrier corresponding to 6G radio access or may transmit an UL signal or channel in a second UL carrier corresponding to 5G/NR radio access but the UL transmissions on the first and the second UL carrier then may occur separately in time-domain, e.g., in different slots or symbols, respectively, and the UE may switch between UL transmissions in the first and the second UL carrier, respectively. For example, the UE supporting 6G radio access may be capable of simultaneous UL transmission in two or more UL carriers in a same band or in different bands of a band combination. For example, a UE supporting 6G radio access using a single carrier or using two or more UL carriers may support a switching or a simultaneous UL transmission capability with respect to some or all UL signals or channel types. For example, the UE may support switching with respect to an UL signal of type SRS. For example, the UE may support simultaneous UL transmission capability with respect to an UL channel of type PUSCH on two or more UL carriers.

The UE (e.g., the UE 116) needs to conform to regulatory requirements such as maximum permissible exposure (MPE) requirements to limit the total RF exposure experienced by a user. RF exposure can fall in two categories. A first category is the specific absorption rate (SAR). SAR applies to frequencies below 6 GHz. SAR is measured in units of Watts/kg and reflects the amount of power absorbed by a certain volume of tissue. A second category is power density (PD) and applies to frequencies above 6 GHz. PD is measured in units of Watts/cm² and reflects the amount of power incident on the surface of tissue. Using Rel-15 NR, SAR is used as metric when taking into account the FR1 band below 6 GHz and PD is used as metric when taking into account the FR2-1 (mmWave) bands.

For example, requirements from the FCC and the International Commission on Non-Ionizing Radiation Protection (ICNIRP) limit the MPE. Limits on SAR and PD are taken into account jointly. The individual SAR and PD values are normalized by the respective regulatory limits as seen in equation (E1):

$${\sum }_{i = 100 kHz}^{6 GHz} \frac{{SAR}_{i}}{{SAR}_{lim}} + {\sum }_{j = 6 GHz}^{300 GHz} \frac{{PD}_{j}}{{PD}_{lim}} \leq 1 \qquad ( E1 )$$

Here, SARᵢ refers to the time-averaged SAR in an RF band i and is determined according to equation (E2) where SARᵢ(τ) is the instantaneous SAR in band i. PDⱼ refers to the time-averaged PD in band j and is given by equation (E3) where PDⱼ(τ) is the instantaneous PD in band. T_{SAR} and T_{PD} are the time windows for averaging, respectively. SARₗᵢₘ is a total regulatory limit for SAR. PDₗᵢₘ is a total regulatory limit for PD. Note that determination of the SAR and the PD is to include transmissions across frequencies and radio technologies of a UE, e.g., including Wi-Fi, or Bluetooth, or wireless transmission other than cellular radio when present.

$${SAR}_{i} = \frac{1}{{T}_{SAR}} {\int }_{t - {T}_{SAR}}^{t} {SAR}_{i} ( τ ) d τ \qquad ( E2 )$$

$${PD}_{j} = \frac{1}{{T}_{PD}} {\int }_{t - {T}_{PD}}^{t} {PD}_{j} ( τ ) d τ \qquad ( E3 )$$

The PD is typically measured over 4 cm² area and is limited to 1 mW/cm². A time averaging of 4 seconds can be used for frequencies from 24 GHz to 42 GHz. The SAR may be limited to 1.6 W/kg measured over 1g of tissue. A time averaging window of 360 seconds can be used. Certain aspects of the measurement or evaluation procedure may vary across regulatory domains or countries.

The time averaging is an important UE implementation aspect when the UE monitors the RF exposure limits such as MPE. For example, the UE can monitor its wireless transmissions and determines or estimates the amount of generated RF exposure using a sliding time window for averaging. The UE can then determine an amount of allowable RF exposure such as MPE for a next period of time such as the next several hundred msec or the next 1 sec. The UE then uses an estimated, e.g., an allowable RF exposure limit to determine a maximum output power while adhering to the parameterization and closed-loop power-control commands from the gNB (e.g., the BS 102) according to the UL transmit power control procedure. For example, when an estimated or an allowable RF exposure limit is determined by the UE to be in excess of RF exposure limits, the UE may then use power class fallback or P-MPR based mitigation to reduce the RF exposure below acceptable levels using Rel-15 NR specifications as further described herein.

Using Rel-15 NR, a UE maximum transmit power or maximum output power can depend on a number of factors such as the UE maximum output power or UE power class (PC) and/or a power reduction that a UE is allowed under certain conditions.

A UE power class such as defined in REFS7-9 defines the maximum output power for any transmission bandwidth within the channel bandwidth of an NR carrier for FR1 or defines the maximum output power radiated by the UE for any transmission bandwidth within the channel bandwidth for FR2. For example, a UE power class may be specified or tested based on conducted or cabled measurements in FR1, or based on over-the-air (OTA) measurements in FR2. For example, the period of measurement may be at least one subframe (1 msec). For example, in the case of FR3, a UE power class may be defined according to FR1 for operating frequencies in the range of 6-8 GHz. For example, in the case of FR3, a UE power class may be defined according to FR2 for operating frequencies in the range of 13 GHz.

Using Rel-15 NR, several UE power classes are defined for FR1, such as power class 1 (PC1), power class 1.5 (PC1.5), power class 2 (PC2), power class 3 (PC3) or power class 4 (PC4). For example, UEs operating within FR1 typically support a maximum output power according to power class 3 (PC3), e.g., 23 dBm, or power class 2 (PC2), e.g., 26 dBm. PC3 may be regarded the default power class for FR1. Power classes 2 or 1.5 may only be applicable to specific operating bands such as applicable in NR bands n78 or n41 but not applicable in NR band n7. PC3 may be applicable for FR1 operating bands.

For example, with reference to 5G/NR and intra-band contiguous or non-contiguous carrier aggregation or inter-band carrier aggregation in FR1, current specifications as defined in REFS7-9 support operation according to PC2 or PC3 wherein PC2 is possible in some band combinations. For example, with reference to 5G/NR and NR inter-band dual-connectivity operation in FR1, current specifications as defined in REFS7-9 support operation according to PC3. For example, with reference to 5G/NR and LTE-NR dual connectivity operation (or EN-DC) in FR1 for the intra-band case, current specifications as defined in REFS7-9 support operation according to PC1.5, PC2 or PC3 wherein PC1.5 or PC2 are possible in some band combinations. For example, with reference to 5G/NR and LTE-NR dual connectivity operation (or EN-DC) in FR1 for the inter-band case, current specifications as defined in REFS7-9 support operation according to PC2 or PC3 wherein PC2 is possible in some band combinations. For example, with reference to 5G/NR and NR-LTE dual connectivity operation (or NE-DC) in FR1 for the inter-band case, current specifications as defined in REFS7-9 support operation according to PC3.

For example, with reference to 5G/NR and single carrier operation in FR2, a maximum EIRP limit may be used to satisfy regulatory requirements, i.e. ensuring that the UE does not transmit at such high power that health issues would be caused, or excessive interference would be caused. A maximum EIRP considers maximum antenna gain which can be generated by the FR2 UE. ‘Mobile’ UEs are specified to have a maximum EIRP of 43 dBm, while ‘transportable’ UEs are specified to have a maximum EIRP of 55 dBm according to REFS7-9. A minimum peak EIRP may be used to ensure that a UE can generate at least a minimum output power in one specific direction. A total radiated power (TRP) for a UE can define an upper limit on the total power radiated in all directions. For example, UEs operating within FR2 may support a power class 1, or 2, or 3, or 4, or 5, or 6, or 7 wherein a power class can correspond to an assumed use case or application which is associated with each UE power class. For example, a FR2 UE power class 1 (PC1), e.g., may support a maximum total radiated power (TRP) of 35 dBm and maximum EIRP of 55 dBm in some bands and correspond to a fixed wireless access (FWA) UE. For example, a FR2 UE power class 2 (PC2) may correspond to a vehicular UE, a FR2 UE power class 3 (PC3) may correspond to a handheld UEs, and a FR2 UE power class 4 (PC4) may correspond to a high power non-handheld UE. For example, a FR2 UE power class 2 may support a maximum TRP of 23 dBm and peak EIRP requirements of 43 dBm and/or a minimum peak EIRP requirement of 29 dBm in some bands. Similar principles with respect to the associated requirements for a FR2 UE power class such as a minimum peak EIRP, or a maximum TRP, or a maximum EIPR can be applied to other FR2 UE power classes such as a FR2 UE power class 7 corresponding to a Redcap UE.

For example, with reference to 5G/NR and intra-band contiguous OR non-contiguous carrier aggregation with a single UL component carrier (CC) configured in the FR2 NR band, a UE maximum output power may correspond to the UE maximum output power and/or FR2 UE power class for single carrier operation. For example, with reference to 5G/NR inter-band UL carrier aggregation with two NR bands and with each UL band configured with a single UL CC, a maximum power requirement may be applicable per band and a maximum output power value for TRP and EIRP may be applicable per carrier, and a minimum peak value for EIRP may be relaxed by a parameter ΔT_{IB,P,n} such as defined in REFS7-9. For example, a spherical coverage requirement for a FR2 UE power class in FR2 inter-band UL carrier aggregation may be considered as met when the intersection set of spherical coverage areas exceeds a common coverage requirement for that power class. For example, with reference to 5G/NR or 4G/LTE and inter-band LTE-NR dual connectivity operation, or EN-DC operation, for an FR1-FR2 EN-DC band combination, separate UE maximum output power requirements may be applied for a carrier in an FR1 band and a carrier in an FR2 band of the EN-DC band combination.

Using Rel-15 NR, a UE may be allowed a power reduction under certain conditions. For example, a first type of power reduction can be allowed for the UE to accommodate higher order modulations and/or transmit bandwidth configurations and may be referred to as maximum power reduction (MPR). A second type of maximum power reduction may be allowed for the UE to meet stringent spectral emission requirements and may be referred to as additional maximum power reduction (A-MPR). A third type of power reduction can be allowed for the UE to accommodate power management maximum power reduction (P-MPR) to comply with MPE requirements. More than one power reduction associated with different types may be applied by the UE for an UL transmission.

An MPR such as defined in REFS7-9 allows the UE to reduce the maximum output power due to higher order modulations and transmit bandwidth configurations. MPR can specify a power back-off for certain NR waveforms such as 16QAM or 64QAM and/or for location of the RBs in the operation band. The UE may not be able to generate and transmit a waveform for the maximum power according to the UE power class while also adhering to adjacent channel leakage ratio (ACLR), in-band emission (IBE), error vector magnitude (EVM) and spectral emission mask (SEM) constraints. For example, MPR values provided in REFS7-9 are chosen such that a UE can still generate a waveform at a reasonable implementation complexity while respecting applicable ACLR, IBE, EVM and/or SEM requirements. For example, an MPR value may be used by the UE to calculate a lower bound on its P_{CMAX,f,c} value. The MPR value numbers may represent the maximum amount of power back-off which is allowed for the UE. The UE may or may not use such a maximum allowance when determining its UL transmit power for an UL transmission for as long as the UE can still meet applicable ACLR, IBE, EVM and/or SEM requirements.

An A-MPR is an additional maximum power reduction allowed for the maximum output power as specified in REFS7-9. For example, the total reduction to the UE maximum output power can be max(MPR, A-MPR). For example, an MPR and/or A-MPR can be based on an outer, inner or edge RB allocation, or a modulation and waveform type, or an associated network signaling label with further details provided in REFS7-9.

A P-MPR is power management maximum power reduction for serving cell. For example, P-MPR may be used by the UE for ensuring compliance with applicable electromagnetic energy absorption requirements such as MPE and/or addressing unwanted emissions or self-de-sense requirements in case of simultaneous transmissions on multiple radio access technologies (RAT(s)) or when proximity detection is used to address such requirements that would require a lower maximum output power. For example, based on the available maximum output transmit power and/or P-MPR of the UE, a gNB may adjust the scheduling decisions. For example, P-MPR may impact the maximum UL performance for the selected UL transmission path.

Using Rel-15 NR, for example, two approaches are for the UE implementation to autonomously reduce its maximum transmit power in order to adjust the UL transmissions according to RF exposure limits such as MPE. One approach is power class fallback when the UE supports a maximum transmit power higher than the default class. Another approach is to use the P-MPR allowance.

For example, using power class fallback, a PC2 UE can indicate to the gNB a maximum UL duty cycle up to which it is able to sustain the output power according to PC2 for its UL transmissions. For FR1, the maximum duty cycle is indicated by the parameter maxUplinkDutyCycle-PC2-FR1 in a UE capability message. When this parameter is not reported by a PC2-capable UE, it is expected to correspond to a default value, e.g., 50%. When UL scheduling occurs using dynamic and/or configured grants and the maximum duty cycle is exceeded, then the UE may operate as a PC3 UE. Similar instances apply to a PC1.5 capable UE. Power class fallback procedures to reduce a UE maximum output power may be used according to conditions such as further specified in REFS7-9. Similarly, P-MPR based behavior may be used by the UE in conjunction with a maximum UL duty cycle to reduce a UE maximum output power as defined in REFS7-9.

In one example for a FR1 PC2 or PC1.5 and single carrier operation, if the field of UE capability maxUplinkDutyCycle-PC2-FR1 is absent and the field of UE capability maxUplinkDutyCycle-PCIdot5-MPE-FR1 is absent and the percentage of UL symbols transmitted in a certain evaluation period is larger than 50% wherein the evaluation period is no less than one radio frame, or if the field of UE capability maxUplinkDutyCycle-PC2-FR1 is not absent and the percentage of UL symbols transmitted in a certain evaluation period is larger than maxUplinkDutyCycle-PC2-FR1, or if the field of UE capability maxUplinkDutyCycle-PCIdot5-MPE-FR1 is not absent and half the percentage of UL symbols transmitted in a certain evaluation period is larger than maxUplinkDutyCycle-PCIdot5-MPE-FR1, or if the IE p-Max is provided and set to the maximum output power of the default power class or lower; the UE applies requirements for the default power class to the supported power class and sets the configured transmitted power as further specified in REFS7-9. If the UE does not support a power class with higher maximum output power than PC2; or if the field of UE capability maxUplinkDutyCycle-PC2-FR1 is absent and the field of UE capability maxUplinkDutyCycle-PCIdot5-MPE-FR1 is absent and the percentage of UL symbols transmitted in a certain evaluation period is larger than 25%; or if the field of UE capability maxUplinkDutyCycle-PC2-FR1 is not absent and the percentage of UL symbols transmitted in a certain evaluation period is larger than 0.5*maxUplinkDutyCycle-PC2FR1, or if the field of UE capability maxUplinkDutyCycle-PCIdot5-MPE-FR1 is not absent and the percentage of UL symbols transmitted in a certain evaluation period is larger than maxUplinkDutyCycle-PCIdot5-MPE-FR1, or if the IE p-Max is provided and set to the maximum output power of the power class 2 or lower; the UE applies requirements for power class 2 to the supported power class and sets the configured transmitted power as further specified in REFS7-9.

In one example for a FR1 PC2 UE and inter-band EN-DC within FR1 operation, if a UE supports a different power class than the default UE power class for an LTE TDD and NR TDD inter-band EN-DC band combination and the supported power class enables higher maximum output power than that of the default power class: if the field of UE capability maxUplinkDutyCycle-interBandENDC-TDD-PC2-r16 is absent and the percentage of NR UL symbols transmitted in a certain evaluation period is larger than 30%, or if the field of UE capability maxUplinkDutyCycle-interBandENDC-TDD-PC2-r16 is not absent and the percentage of NR UL symbols transmitted in a certain evaluation period is larger than maxUplinkDutyCycle-interBandENDC-TDD-PC2-r16, or if the IE p-maxUE-FR1 is provided and set to the maximum output power of the default power class or lower, the UE applies requirements for the default power class to the supported power class and sets the configured transmitted power; else if the IE p-maxUE-FR1 is not provided or set to the higher value than the maximum output power of the default power class and the percentage of NR UL symbols transmitted in a certain evaluation period is less than or equal to maxUplinkDutyCycle-interBandENDC-TDD-PC2-r16, or if the IE p-maxUE-FR1 is not provided or set to the higher value than the maximum output power of the default power class and the percentage of NR UL symbols transmitted in a certain evaluation period is less than or equal to 30% when maxUplinkDutyCycle-interBandENDC-TDD-PC2-r16 is absent, the UE applies requirements for the supported power class and sets the configured transmitted power class as specified in REFS7-9.

For example, MPR based mitigation behavior may be used by the UE in conjunction with a maximum UL duty cycle to reduce a UE maximum output power as defined in REFS7-9. The UE may indicate or report a parameter maxUplinkDutyCycle-FR2 to the gNB, or a default value for the associated maximum UL duty may be assumed, wherein maxUplinkDutyCycle-FR2 is a UE capability to facilitate electromagnetic power density exposure requirements and may be associated with an FR2 power class.

In one example for a FR2 UE, if the field of UE capability maxUplinkDutyCycle-FR2 is present and the percentage of UL symbols transmitted including any PRACH transmission within any 1 sec evaluation period is larger than maxUplinkDutyCycle-FR2, the UE can follow the UL scheduling and can apply P-MPR_{c}. If the field of UE capability maxUplinkDutyCycle-FR2 is absent, the compliance to electromagnetic power density exposure requirements may be ensured by the UE by means of scaling down the power density or by other means, as further specified in REFS7-9.

For example, a term “max UL duty cycle” may refer to the reported UE capability, e.g., maxUplinkDutyCycle-FR2. For example, a term “UL duty cycle” may refer to the “actual” or “observed” UL usage ratio as evaluated during system operation. Existing technology as defined in REFS7-9 introduces an P-MPR term in the P_{CMAX,f,c} equation such that the UE can report to the gNB the available maximum output power but does not introduce the P-MPR term in relation to an UL duty cycle of the UE.

For example, in the case of FR2 operation and for a single NR carrier, the UE determines the single UL duty cycle as “percentage of UL symbols transmitted during a certain evaluation period”. According to system operating procedures defined in REFS7-9, the UE is only allowed to apply P-MPR based mitigation behavior for these three specific scenarios: to ensure compliance with MPE requirements, to reduce lower maximum output power in case of proximity detection, or to address unwanted emissions or self-defense requirements in case of simultaneous transmissions on multiple RATs when a non-3GPP RATs is involved.

For example, in the case of FR2 “UL MIMO” or “Simultaneous transmission to multiple directions” operation, a separate nominal P-MPR value which the UE can determine/apply is associated with each of indicated joint/UL TCI states. The UE behavior may include that, if (Max UL duty cycle is reported by UE Cap) & (UL duty cycle>max), then the UE follows UL scheduling and can apply P-MPR. Otherwise, the UE can scale down the PSD or can apply other means. For example, in the case of FR2 intra-band or inter-band CA operation with a single UL component carrier, the UE behavior may be the same as above.

For example, in the case of FR2 inter-band CA operation with two UL component carriers (i.e., one in each band), the UE determines an UL duty cycle as “percentage of UL symbols transmitted during a certain evaluation period.”. The same counting across carriers/bands or separate counting may be used. The UE nominally determines/applies separate P-MPR values per UL component carrier. Otherwise, unspecified behavior incl. P-MPR_{X} for band X or P-MPR_{Y} for band Y, respectively, i.e., is left to UE implementation.

For example, for other case such as FR1-FR2 EN-DC or NR-NR DC operation, the UE separately/independently applies any applicable FR1 requirements to the FR1 carrier/band, and any applicable FR2 requirements to the FR2 carrier/band of the band combination.

Embodiments of the present disclosure recognize and take into consideration the following. For FR1, a P-MPR such as defined in REFS7-9 is provided in a PC_{MAX,f,c} equation with respect to PHR reporting and there is no associated UL duty cycle related behavior. For example, for FR2 single NR carrier operation or NR intra-band or inter-band DL carrier aggregation operation using a single UL carrier, the UE determines a “single UL duty cycle” and is allowed to apply P-MPR when its Max UL duty cycle is reported in UE cap and actual/observed UL duty cycle>max as defined in REFS7-9. Any max/min/limit, applicability, duration, etc. related to P-MPR based mitigation behavior is not specified. Additionally, for the case of MIMO or for the case of simultaneous transmission to multiple directions as defined in REFS7-9, P-MPR is then associated with each of the indicated joint/UL TCI states. For the case of FR2 operation or for the case of inter-band carrier aggregation using two UL carriers (i.e., one in each band) a separate or independent nominal P-MPR is associated with each UL carrier as defined in REFS7-9. For the case of FR1-FR2 dual connectivity such as LTE-NR or NR-NR, a P-MPR can be applied to the FR2 carrier/band as in single NR carrier case but independent from the FR1 carrier/band.

With reference to detailed NR UL transmit power control procedures according to Rel-15 NR, a UE determines an UL transmission power for PUSCH, PUCCH, SRS, and PRACH transmissions.

Using Rel-15 NR, the NR UL transmit power control is based on a combination of open-loop power control (OLPC) and closed-loop power control (CLPC) components. OLPC includes support for fractional pathloss compensation where the UE estimates a pathloss to a serving gNB, based on measurements for DL signals/channels from the serving gNB, and accordingly adjusts a transmission power. CLPC is based on transmit power control (TPC) commands provided by the gNB where, for example, the gNB may determine values for the TPC commands to the UE based on measurements of the received power for transmissions from the UE. The NR UL power control procedure also supports beam-based power control.

If a UE transmits a PUSCH on active UL BWP b of carrier f of serving cell c using parameter set configuration with index j and PUSCH power control adjustment state with index l, the UE determines the PUSCH transmission power P_{PUSCH,b,f,c(i,j,qd,l)} in dBm in PUSCH transmission occasion i as,

$${P}_{PUSCH , b , f , c} ( i , j , {q}_{d} , l ) = min \{ \begin{matrix}\begin{matrix}{P}_{CMAX , f , c} ( i ) , \\ {P}_{O \_ PUSCH , b , f , c} ( j ) + 10 {log}_{10} ( {2}^{µ} \cdot {M}_{RB , b , f , c}^{PUSCH} ( i ) ) +\end{matrix} \\ {α}_{b , f , c} ( j ) \cdot {PL}_{b , f , c} ( {q}_{d} ) + {Δ}_{TF , b , f , c} ( i ) + {f}_{b , f , c} ( i , l )\end{matrix} \}$$

P_{CMAX}(.) is the configured maximum UE output power per carrier. P₀(.) corresponds to a normalized target received power level that may be indicated by a serving gNB using one or multiple signaled higher layer parameters. PL (.) corresponds to a pathloss estimate by the UE, for example based on an SSB or a NZP CSI-RS. α(.) is a parameter for fractional pathloss compensation that is indicated by the serving gNB. M_{RB}(.) corresponds to the number of RBs for the PUSCH transmission when adjusting a normalized (per RB and 15 kHz SCS) target receive power. Δ_{TF}(.) may be associated with a modulation scheme and channel-coding rate used for the data information provided by the PUSCH transmission and can be viewed as modeling link capacity such as 80% of Shannon capacity. This term may not be included when determining a PUSCH transmit power and can be applicable only for single-layer UL transmissions. f(.) corresponds to a power adjustment state due to the CLPC component.

The configured maximum output power P_{CMAX,f,c} accounts for the UE power class, a maximum power reduction such as MPR, A-MPR, and/or P-MPR, and is set within the following bounds as described in REFS7-9:

$${P}_{CMAX \_ L , f , c} \leq {P}_{CMAX \_ H , f , c}$$

$$with$$

$${P}_{CMAX \_ L , f , c} = MIN \{ {P}_{EMAX , c} - {ΔT}_{C , c} , ( {P}_{PowerClass} - {Δ P}_{PowerClass} ) - MAX ( \text{} MAX ( \text{} {MPR}_{c} + {Δ MPR}_{c} , A - {MPR}_{c} ) + {Δ T}_{IB , c} + {Δ T}_{C , c} + {Δ T}_{RxSRS} , P - {MPR}_{c} ) \}$$

$$and$$

$${P}_{CMAX \_ H , f , c} = MIN \{ {P}_{EMAX , c} , {P}_{PowerClass} - {Δ P}_{PowerClass} .$$

Here, P_{EMAX,c} is provided by higher layer provided parameter p-Max or by the field additional Pmax of the higher layer parameter NR-NS-PmaxList, as described in REF6. P_{PowerClass} is the maximum UE power of the applicable UE power class specified in REFS7-9 without taking into account the tolerances specified in REFS7-9. The parameter p-Max (range from −30 . . . 33) is used to limit the UE's transmission power on a carrier frequency and may also be used for the UE to calculate compensation factors during cell (re-)selection in RRC_IDLE and/or RRC_INACTIVE states. p-Max is the maximum transmit power allowed in a serving cell with value in dBm.

In addition to limiting a UE transmit power on a serving cell, a total UE transmit power over serving cells for the UE may also be limited. Such a limitation of the UE transmit power over multiple UL carriers may also apply in case of LTE/NR dual connectivity. For example, a maximum transmit power that the UE may use on a serving cell may then be additionally limited by parameters p-NR-FR1 configured for the cell group and p-UE-FR1 configured total power for serving cells operating on FR1. If absent, the UE applies the maximum power according to REFS7-9 in case of an FR1 cell or an FR2 cell. Further details are described in REFS7-9.

The sum P₀(.)+α(.) PL(.) is associated with OLPC and, for α(.)<1, it includes fractional pathloss compensation. For full pathloss compensation (α(.)=1), OLPC adjusts the PUSCH transmit power such that the received power aligns with the target received power P₀(.). For example, P₀(.) may be selected and indicated by the gNB to the UE depending on the target data rate and/or the noise and interference level experienced at the gNB receiver for the UE. For fractional pathloss compensation (α(.)<1), pathloss is not fully compensated while interference to neighbor cells is reduced. The gNB received power for transmissions from a UE may, on average, vary depending on the UE location within the serving cell. For example, for partial pathloss compensation, PUSCH transmissions from UEs experiencing larger pathloss, due to being at larger distances from the gNB, may be received by the gNB with lower power that PUSCH transmissions from UEs experiencing smaller pathloss. The gNB may compensate by adjusting the UL data rate of UEs accordingly and operate UEs located closer to the gNB with larger data rates than UEs located further from the gNB. In consequence, there may be larger variations in the service quality and reduced data rate availability for UEs further from the gNB (closer to the cell border) when using fractional pathloss compensation.

NR UL transmit power control procedures support beam-based power control. For example, a UE can be configured multiple DL reference signals for pathloss measurements, multiple OLPC parameter sets, and multiple CLPC processes.

In the case of beamforming, a pathloss estimate PL(.) that a UE uses to determine a transmit power should reflect the path loss, including the beamforming gains, of the paired UL beam that the UE uses to transmit a PUSCH. When DL/UL beam correspondence is assumed, the UE can estimate the pathloss based on measurements for a DL reference signal that is transmitted by the gNB over the corresponding paired DL beam. As the UL beam used for UL/DL beam pair may change across PUSCH transmissions, the UE may need to maintain multiple pathloss estimates corresponding to different candidate UL/DL beam pairs. The gNB can configure the UE with a set, such as up to 4, of DL reference signals for pathloss measurements, such as SSBs and/or NZP CSI-RSs. The gNB can also configure a mapping among SRS resource indicator (SRI) values and pathloss DL reference signals. A DCI format scheduling a PUSCH transmission can include a SRI field indicating one of the SRI values and the UE uses a pathloss estimate obtained from the DL RS associated with the indicated SRI value to determine a pathloss value to apply for the determination of the transmit power for the PUSCH transmission.

A UE can be configured multiple, such as up to 30, OLPC parameter sets {P₀(.), α(.)} each corresponding to a pair of values for a normalized target receive power level and a fractional pathloss compensation coefficient. A UE may use parameter pair {P₀(1), α(1)} for PUSCH transmissions associated with configured grants while remaining parameter pairs are associated with PUSCH transmissions scheduled by DCI formats. The gNB may associate each value of the SRI field in a DCI format with one of the indicated OLPC parameter set pairs. For example, the gNB may select and indicate an OLPC parameter set using separate values for normalized target receive power level and fractional pathloss compensation coefficient, respectively, for each UL beam that can be used by the UE to transmit a PUSCH. For a PUSCH transmission before the UE receives dedicated configuration for OLPC parameters, such as for a Msg3 PUSCH transmission or for a PUSCH transmission scheduled by a DCI format with CRC scrambled by a temporary C-RNTI (TC-RNTI), fractional power control is not used, e.g., α(.)=1, and P₀(.) may be determined by the UE based on received information in the configuration of the random-access procedure.

With respect to multiple OLPC parameter sets, NR supports for a UE (e.g., the UE 116) to be configured with up to three values for the normalized target receive power P₀(.) resulting to up to three respective values for a PUSCH transmit power. A DCI format scheduling the PUSCH transmission can indicate one of the P₀(.) values for the UE to use in determining a power for the PUSCH transmission. For example, a DCI format 0_1 or a DCI format 0_2 may be configured to include a OLPC parameter set indication field and its associated index values are indicated by higher layer signaling such parameter P0-PUSCH-Set-r16 as described in REF2 and REF6. The OLPC parameter set indication field has length of 1 bit when the DCI format scheduling the PUSCH transmission also includes the SRI field and has length of 1 bit or 2 bits when the SRI field is not present. It is noted that the OLPC parameter set indication field indicates only the normalized target receive power setting P₀(.) and does not indicate the fractional pathloss coefficient α(.).

A UE can be configured with two SRS resource sets. Values of two SRS resource set indicator fields in a DCI format scheduling a PUSCH transmission can indicate a first and a second normalized target receive power P₀(.) from a first and a second OLPC parameter set p0-PUSCH-Alpha and p0-PUSCH-Alpha2, respectively, that is provided by higher layers. Determination of the target receive power and fractional pathloss compensation coefficient by the UE is per SRI field as in the case of a single SRI field in the DCI format.

Furthermore, the UE can be configured with multiple, such as 2, independent CLPC processes. Similar to having multiple pathloss DL reference signals and multiple OLPC parameter sets, the selection of the associated CLPC process by the UE can be configured by higher layers for the SRI value indicated by the DCI format.

The corresponding UL transmit power procedures for the cases of other UL channels or signals such as PUCCH, SRS or PRACH are further described in REF3.

With reference to detailed 5G/NR procedures for single cell operation with two uplink carriers or for operation with carrier aggregation or for operation with a candidate cell configured by LTM-Config, if a total UE transmit power for PUSCH or PUCCH or PRACH or SRS transmissions on serving cells or on a candidate cell, if any, in a frequency range in a respective transmission occasion i would exceed \hat{P}_{CMAX}(i), where \hat{P}_{CMAX}(i) is the linear value of P_{CMAX}(i) in transmission occasion i as defined in REFS7-9, the UE allocates power to PUSCH/PUCCH/PRACH/SRS transmissions according to a certain priority order so that the total UE transmit power for transmissions on serving cells or on a candidate cell, if any, in the frequency range is smaller than or equal to \hat{P}_{CMAX}(i) for that frequency range in every symbol of transmission occasion i.

A descending priority order from higher to lower priority is defined by system operating specifications in REF3 according to: (1) a PRACH transmission on a candidate cell; (2) a PRACH transmission on the PCell; (3) PUCCH or PUSCH transmissions with larger priority index; (4) for PUCCH or PUSCH transmissions with same priority index a PUCCH transmission with HARQ-ACK information, and/or SR, and/or LRR, or a PUSCH transmission with HARQ-ACK information of the priority index, PUCCH or PUSCH transmission with CSI, PUSCH transmission without HARQ-ACK information of the priority index or CSI and, for Type-2 random access procedure, PUSCH transmission on the PCell; (5) if the UE is configured with a parameter prioSCellPRACH-OverSP-PeriodicSRS-r17, aperiodic SRS transmission or PRACH transmission on a serving cell other than the PCell, semi-persistent and/or periodic SRS transmission; and (6) otherwise an SRS transmission, with aperiodic SRS having higher priority than semi-persistent and/or periodic SRS, or a PRACH transmission on a serving cell other than the PCell.

In case of same priority order and for operation with carrier aggregation, the UE may prioritize power allocation for transmissions on the primary cell of the MCG or the SCG over transmissions on a secondary cell. In case of same priority order and for operation with two UL carriers, the UE may prioritize power allocation for transmissions on the carrier where the UE is configured to transmit PUCCH. If PUCCH is not configured for any of the two UL carriers, the UE may prioritize power allocation for transmissions on the non-supplementary UL carrier. Further details are described in REF3.

With reference to detailed 5G/NR procedures for dual connectivity operation, the UE may be configured with a maximum transmission power for transmissions on an MCG or an SCG wherein the MCG or the SCG may operate according to 4G/LTE or to 5G/NR.

For example, if a UE is configured with an MCG using LTE radio access and with an SCG using NR radio access, i.e., EN-DC operation or LTE-NR dual connectivity operation, the UE is configured a maximum power P_{LTE} for transmissions on the MCG by parameter p-MaxEUTRA and a maximum power P_{NR} for transmissions in FR1 on the SCG by p-NR-FR1. The UE determines a transmission power for the MCG according to REF9 using P_{LTE} as the maximum transmission power. The UE determines a transmission power for the SCG in FR1 or FR2 as described in REF3 using P_{NR} as the maximum transmission power. Certain limitations may apply with respect to an LTE configuration. For example, the UE does not expect to be configured for operation with the LTE shortened TTI and/or processing time features on a cell that is included in an EN-DC configuration.

If a UE is configured with

$${\hat{P}}_{LTE} + {\hat{P}}_{NR} > {\hat{P}}_{Total}^{EN - DC} ,$$

where \hat{P}_{LTE} is the linear value of P_{LTE}, \hat{P}_{NR} is the linear value of P_{NR}, and

$${\hat{P}}_{Total}^{EN - DC}$$

is the linear value of a configured maximum transmission power for EN-DC operation as defined in REFS7-9, the UE may determine a transmission power for the SCG as follows. Note that if the UE does not indicate a capability for dynamic power sharing between LTE and NR for EN-DC, the UE expects to be configured with a reference TDD configuration for 4G/LTE by parameter tdm-PatternConfig according to REF9.

If the UE is configured with a reference TDD configuration for LTE by a parameter tdm-PatternConfig or by tdm-PatternConfig2 in REF9: if the UE does not indicate a capability for dynamic power sharing between LTE and NR for EN-DC, the UE does not transmit in a slot on the SCG in FR1 when a corresponding subframe on the MCG is an UL subframe in the reference TDD configuration; if the UE indicates a capability for dynamic power sharing between E-UTRA and NR for EN-DC, and does not indicate a capability tdm-restrictionDualTX-FDD-endc-r16, and is configured with tdm-PatternConfig2, the UE does not transmit on the SCG in FR1 when the UE has overlapped transmission on a subframe on the MCG.

If the UE indicates a capability for dynamic power sharing between LTE and NR for EN-DC and if UE transmission(s) in subframe i₁ of the MCG overlap in time with UE transmission(s) in slot i₂ of the SCG in FR1, and if

$${\hat{P}}_{MCG} ( {i}_{1} ) + {\hat{P}}_{SCG} ( {i}_{2} ) > {\hat{P}}_{Total}^{EN - DC}$$

in any portion of slot i₂ of the SCG, the UE reduces transmission power in any portion of slot i₂ of the SCG so that

$${\hat{P}}_{MCG} ( {i}_{1} ) + {\hat{P}}_{SCG} ( {i}_{2} ) \leq {\hat{P}}_{Total}^{EN - DC}$$

in any portion of slot i₂, where \hat{P}_{MCG}(i₁) and \hat{P}_{SCG}(i₂) are the linear values of the total UE transmission powers in subframe i₁ of the MCG and in slot i₂ of the SCG in FR1, respectively. The UE is not required to transmit in any portion of slot i₂ of the SCG if \hat{P}_{SCG} (i₂) would need to be reduced by more than the value provided by X_{SCALE} in order for

$${\hat{P}}_{MCG} ( {i}_{1} ) + {\hat{P}}_{SCG} ( {i}_{2} ) \leq {\hat{P}}_{Total}^{EN - DC}$$

in any portion of slot i₂ of the SCG. The UE is required to transmit in slot i₂ of the SCG if \hat{P}_{SCG}(i₂) would not need to be reduced by more than the value provided by X_{SCALE} in order for

$${\hat{P}}_{MCG} ( {i}_{1} ) + {\hat{P}}_{SCG} ( {i}_{2} ) \leq {\hat{P}}_{Total}^{EN - DC}$$

in all portions of slot i₂.

Further details for the case of NE-DC operation, i.e., NR-LTE dual connectivity operation, or for the case of NR-DC operation, i.e., NR-NR dual connectivity operation, are defined in REF3.

When considering UE procedures for UE transmitter power and UL transmit power control for operation in wireless communications systems, several issues related to limitations and drawbacks of existing technology need to be overcome in order to increase the UE communications range, or to increase the UE data throughput rate, or to improve system operation according to channel conditions.

It needs to be considered that for receptions in the UL by a gNB in a network deployment supporting one or more RATs in one or more bands, a different number of receiver antennas or panels, a different effective receive antenna aperture area, or a different receive antenna directivity setting may be available for receptions in a first band corresponding to the first RAT, e.g., 6G radio access, and for receptions in the second band corresponding to the second RAT, e.g., 5G/NR radio access, when compared to receptions in a same band. An antenna or panel configuration in either or both bands at the gNB may not be known to a UE. Similar considerations may be applied with respect to transmissions in the DL from the gNB.

For example, the network deployment may support a 16 TRX panel with 64 antenna elements in a panel in an FR1 band such as n3/n7 for 5G/NR radio access, or may support a 64 TRX panel with 128 antenna elements in a panel in an FR1 band such as n77/78 for 5G/NR radio access, or may support a 256 TRX panel with 768 antenna elements in a panel in an FR3 band such as 7-8 GHz for 6G radio access.

Furthermore, the processing gain and a corresponding received signal-to-noise/interference ratio of an UL signal/channel may not be the same for receptions in the first and the second RATs, respectively. It can be expected that 6G radio access can improve upon the demodulation and multiplexing performance of 5G/NR radio access due to aspects such as advances in signal/channel design, multiplexing, channel coding, beamforming, or multiple-antenna operation, or modem processing, or AI/ML.

It is considered that a network loading and the corresponding interference levels experienced by the gNB receiver may differ between receptions in the first band corresponding to the first RAT, e.g., 5G/NR radio access, and the second band corresponding to the second RAT, e.g., 6G radio access, respectively.

For example, it may be expected that a network loading in FR1 bands such as n1, or n3 or n7 in 2 GHz bands using 5G/NR radio access is initially higher than a network loading in an FR3 band such as 7-8 GHz. A factor is an initially expected low penetration or availability rate of UEs supporting 6G radio access and a continued use of 5G/NR radio access in the 5G/NR bands of the deployment. For example, it can be expected that network loading and corresponding interference levels experienced by the gNB receiver in the second band corresponding to 6G radio access may increase over time as penetration rate or availability of 6G capable UEs increase. For example, it can be expected that network loading and corresponding interference levels in the 5G/NR band and the 6G band, respectively, may vary depending on network processing capabilities and operator deployment considerations.

Therefore, the resulting signal reception and/or interference power levels and their variation experienced by the gNB receiver may not be same for reception of a signal/channel in the first band corresponding to the first RAT when compared to reception of the signal/channel in the second band corresponding to the second RAT. For example, a UE transmission power for UL transmissions from the UE may not be same for a signal/channel in the first band corresponding to the first RAT when compared to UL transmission by the UE of the same signal/channel in the second band corresponding to the second RAT even if a same receive operating SINR target value for UL reception in the first and the second band would apply.

Using existing technology, a first issue relates to a maximum UL duty cycle, or a UE power class fallback behavior, or an MPR based mitigation behavior according to the existing 4G/LTE or 5G/NR specifications, for example to ensure compliance with the applicable electromagnetic energy absorption requirements based on MPE requirements or unwanted emissions or self-de-sense requirements.

Using existing technology and 5G/NR based radio access, a UE can apply MPR based mitigation behavior and reduce a maximum output power in an FR1 or FR2 band for single carrier operation, or for NR carrier aggregation, or for NR-NR dual connectivity operation. Note that for inter-RAT dual connectivity operation, e.g., for EN-DC with 4G/LTE radio access on the PCG and 5G/NR radio access on the SCG, the UE may apply MPR based mitigation behavior on a carrier corresponding tot 5H/NR radio access of a band combination. In FR2, the use of MPR based mitigation behavior by the UE may be subject to a supported or a default maximum UL duty cycle. In FR1, the use of MPR based mitigation is left to UE implementation and a P-MPR term is introduced in the P_{CMAX,f,c} equation such that the UE can report to the gNB the available maximum output power. Similar considerations with respect to the different associated specification behaviors between P-MPR in the FR1 and FR2 cases apply for the CA or DC band combinations within FR1, or within FR2, or across FR1 and FR2.

In one example, a UE indicating or declaring support for an inter-band NR-DC configuration between FR1 and FR2 (two bands) according to DC_1A-n257A using existing technology is considered. 5G/NR radio access is used for the FDD NR band 1 (2 GHz), and for the TDD NR band 257 (26-29 GHz). For example, the UE may indicate or report to the gNB a supported (higher than default) FR1 UE PC2 for the FR1 band in the band combination, and indicate or report an FR2 PC3 corresponding to Handheld UE for the FR2 band in the band combination. For example, a supported or a default maximum UL duty cycle in FR1 or FR2 may be expressed as the percentage X of UL symbols in a certain evaluation period. For example, the UE may indicate or report to the gNB a value X_{FR1}=50% in a field of UE capability parameter maxUplinkDutyCycle-PC2-FR1 for the FR1 band and a value X_{FR2}=30% in a field of parameter maxUplinkDutyCycle-FR2 for the FR2 band of the FR1-FR2 band combination. When the UE is configured or indicated for a number of UL transmissions in a period in the first band, i.e., FR1 band n1, and exceeds the value of the supported maximum UL duty cycle X_{FR1}, the UE would then autonomously reduce its maximum output power in the FR1 band based on UE power class fallback behavior. For example, a UE supporting FR1 PC2, or 26 dBm, may then employ power-class fallback and accordingly reduce the UE maximum output power according to the default FR1 PC3, or 23 dBm, on the carrier in the FR1 band of the FR1-FR2 band combination. When the UE is configured or indicated for a number of UL transmissions in a period in the second band, i.e., FR2 band n257, and exceeds the value of the supported maximum UL duty cycle X_{FR2}, the UE would then autonomously reduce its maximum output power in the FR2 band based on MPR based mitigation behavior. For example, a UE supporting FR2 PC3 may reduce the maximum output power by a P-MPR value, e.g., 10 dB on the carrier in the FR2 band of the FR1-FR2 band combination.

In another example, a UE indicating or declaring support for an inter-band CA configuration in FR2 according to CA_n257-n260 using existing technology is considered. 5G/NR radio access is used for the TDD NR bands 257 (26-29 GHz) and 260 (37-40 GHz). For example, the UE may indicate or report to the gNB a supported FR2 PC1 corresponding to Fixed Wireless Access UE for the FR2 bands in the band combination. For example, a supported or a default maximum UL duty cycle in FR2 may be expressed as the percentage X of UL symbols in a certain evaluation period. For example, the UE may indicate or report to the gNB a value X_{FR2}=30% in a field of parameter maxUplinkDutyCycle-FR2 for the FR2 bands of the band combination. When the UE is configured or indicated for a number of UL transmissions in a period in the first band, i.e., FR2 band n257, and exceeds the value of the supported maximum UL duty cycle X_{FR2}, the UE may autonomously reduce its maximum output power by a P-MPR value such as P-MPRₙ₂₅₇=10 dB on the carrier in the FR2 band n257 of the band combination. When the UE is configured or indicated for a number of UL transmissions in a period in the second band, i.e., FR2 band n260, and exceeds the value of the supported maximum UL duty cycle X_{FR2}, the UE may autonomously reduce its maximum output power by a P-MPR value such as P-MPRₙ₂₆₀=3 dB on the carrier in the FR2 band n260 of the band combination. When the UE is configured or indicated for a number of UL transmissions in a period in the first or second band, i.e., FR2 bands n257 or n260, and exceeds the value of the supported maximum UL duty cycle X_{FR2}, the UE may autonomously reduce its maximum output power by a P-MPR value such as P-MPR=5 dB on the carrier in the FR2 band n257 and n260 of the band combination.

When MPR based mitigation behavior is applied by the UE to determine a maximum output power on a carrier or in band, the maximum UL performance for the selected UL transmission path may be impacted. For example, an UL coverage, or a throughput of the UE, or a gNB scheduling efficiency, or a radio link reliability for UL transmissions from the UE is reduced. One reason is that the gNB may not become instantly aware of when and under which conditions a UE applies MPR based mitigation behavior in the network deployment with 6G radio access. Furthermore, using existing technology, the gNB is not able to set or adjust a P-MPR value determined by the UE with respect to a reduced UE maximum output power on a carrier or in a band. Furthermore, existing technology does not provide means for the gNB to control or adjust a UE maximum output power with respect to a carrier or a band in a band combination. This is undesirable because an UL coverage or UL throughput on the carrier or in the band is then reduced accordingly, and/or UL link interruptions for the UE can result. When considering that gNB receiver performance may differ between receptions in the first band corresponding to the first RAT, e.g., 5G/NR radio access, and the second band corresponding to the second RAT, e.g., 6G radio access, respectively, a need to control or adjust a desired maximum output power on a carrier or band using 6G radio access may increase. One reason is the motivation to preferably last reduce a maximum output power on a carrier or in a band using 6G radio access.

For example, using existing technology, the gNB may attempt to count or to track a number or scheduled or configured UL symbols for the UE in the first or the second carrier or band to determine an UL duty cycle for the UE. However, RF exposure such as MPE is autonomously estimated by the UE and can also depend on other factors such as other concurrently active radio transmitters in the UE implementation, an orientation of the device, or an evaluation period over which MPE is assessed by the UE, all of which may be unknown to the gNB. Furthermore, when the UE does not transmit using a high output power level or has not reached the maximum output power according to its power class, the UE may not apply power class fallback in FR1 or MPR based mitigation behavior in FR2 even if a maximum duty cycle is exceeded. Using existing technology, autonomy is given to the UE implementation and in consequence, the ability of the gNB to accurately estimate an available UL transmit power from the UE for a particular UL scheduling or UL transmission instance is reduced.

For example, using existing technology when operating in FR2, the UE may provide a P-MPR indication to the gNB. For example, using power headroom reporting (PHR) in a MAC CE, a UE can report its instantaneous transmit power to transmit a PUSCH. The PHR can consist of a power headroom value of 6 bits, a P_{CMAX,f,c} value of 6 bits, and a P-MPR value of 2 bits. The power headroom value reflects an amount of additional transmit power a UE can support when compared to the current PUSCH transmit power level. P_{CMAX,f,c} reflects the corresponding maximum power a UE could support. The P-MPR value from the UE to the gNB indicates a range within which a P-MPR was autonomously applied by the UE to the current transmission. However, the PHR can only provide information to the gNB reactively, e.g., after the fact. Future UE behavior, including a future adjustment of the MPR based mitigation behavior by the UE cannot be inferred by the gNB. Furthermore, the gNB cannot set or adjust a UE-reported P-MPR value. Similar considerations apply to UE power class fallback behavior in FR1 using existing 5G/NR or 4G/LTE radio access, i.e., future UE behavior with respect to the maximum output power determined by the UE for an UL transmission instance in a period may not be accurately known or predicted or adjusted by the gNB.

It is considered that a use of a same MPR based mitigation behavior by the UE for the carriers or the bands in a band combination is less motivated for the FR2 bands, or for band combinations using an FR2 band and an FR3 band such as 14-15 GHz, or for band combinations using an FR1 band and an FR3 band such as 7-8 GHz due to wider available frequency separation between the bands when compared to the existing FR1 band combinations for inter-band CA, or EN-DC, or NR-NR DC. For example, a wider frequency separation between an FR2 band and an FR3 band can reduce a need to employ same a maximum power reduction in a band to maintain an UL transmission signal quality or to reduce a DL demodulation performance degradation potentially arising from RF constraints such as 2^{nd} or 3^{rd} order intermodulation products. This can enable RF operation for the UE which is subject to fewer constraints. Similar considerations may be applied to other operating scenarios such as NR-NR dual-connectivity or dual-active protocol stack operation for dual RAT UEs supporting 5G/NR and 6G radio access in FR1, FR2 and FR3, respectively.

Therefore, existing technology is insufficient to control or adjust the UE transmitter power and perform the UL transmit power control when operating in a wireless communication system.

Accordingly, there is a need for separate control or adjustment of the UE transmitter power and UL transmit power control for bands using the 6G radio access and the 4G/LTE or the 5G/NR radio access, respectively, while ensuring compliance with applicable electromagnetic energy absorption requirements such as MPE and/or unwanted emissions or self-de-sense requirements.

In various embodiments, separate MPR based mitigation behavior across FR1, or FR2, or FR3 carriers or bands (instead of one same behavior) with 5G/NR or 6G radio access, respectively, in a band combination with CA, DC or dual stack operation is provided. In various embodiments, the provided MPR based mitigation behavior, i.e., indicated by gNB or specified, is set or adjusted to a same, separate, or separate MPR mitigation behavior for the 5G/NR carrier or band and the 6G carrier or band, respectively, or the first 6G carrier or band and the second 6G carrier or band in the band combination. In various embodiments, the provided MPR based mitigation behavior corresponding to a requested carrier or band, is associated with a priority level or a condition, a duration, and an activation timing to apply the MPR based mitigation behavior on a carrier/band. Various embodiments provide supporting aspects including signaling realization and MPR based mitigation behavior in UE capability and/or UE assistance. Various embodiments provide adjustment or scaling factors. Various embodiments provide for power headroom reporting.

In one embodiment, a UE is provided with information to determine a first maximum power reduction (MPR) value corresponding to UL transmissions on a first RAT and a second MPR value on a second RAT of a band combination. In another embodiment, a UE is provided with information to determine a first maximum power reduction (MPR) value corresponding to UL transmissions on a first carrier or band and a second MPR value on a second carrier or band of a band combination. Based on the first or the second MPR value, the UE further determines an applied MPR value for an UL transmission in a band of the band combination. Based on the applied MPR value, the UE further determines an UL transmission power using the applied MPR value. For example, the first RAT corresponds to 6G radio access, and the second RAT corresponds to one of 5G/NR or 4G/LTE radio access. For example, the first carrier or band corresponds to 6G radio access, and the second carrier or band corresponds to 6G radio access. In one embodiment, the band combination corresponds to a carrier aggregation band combination. In another embodiment, the band combination corresponds to a dual connectivity band combination or a band combination for a UE simultaneously connected to the first RAT and the second RAT. In another embodiment, the MPR value corresponds to a P-MPR value.

In one embodiment, the UE further determines an evaluation mode associated with the first or the second MPR value corresponding to the first and the second carrier or band, respectively, to further determine an applied MPR value and further determine the UL transmit power. In another embodiment, the UE further determines an evaluation mode associated with the first or the second MPR value corresponding to the first and the second RAT, respectively, to further determine an applied MPR value and further determine the UL transmit power. For example, the evaluation mode corresponds to a same, a separate or a joint/common evaluation mode. Using same evaluation mode, the UE determines a same applied MPR value based on first or second MPR value for the first and the second carrier, respectively. Using separate evaluation mode, the UE determines a first and a second applied MPR value corresponding to first and second carrier, respectively. The UE may alternatively use a joint/common evaluation mode.

In one embodiment, the UE further determines an applied MPR value based on the first and the second MPR value corresponding to the first and the second carrier or band, respectively, to determine the UL transmit power. In another embodiment, the UE further determines an applied MPR value based on the first and the second MPR value corresponding to the first and the second RAT, respectively, to determine the UL transmit power. The applied MPR value is determined as max, as min, or as equal weight average, or as scaled average of the first and second MPR values. In another embodiment, the UE is provided with information selecting or prioritizing a carrier or a band to apply an MPR value. In another embodiment, an MPR value is applied to an UL transmission corresponding to a first type of UL signal or channel in a carrier or a band and the MPR value is not applied when not corresponding to the first type of UL signal or channel. The type may correspond to PUSCH, PUCCH, PRACH, or SRS. In another embodiment, an MPR value on a carrier or in a band is applied when exceeding a minimum UL transmission duration and not applied when equal or less than the minimum transmission duration.

In certain embodiments, the term ‘P-MPR” is used as a short form for a power management maximum power reduction value or term. A value or term such as ‘P-MPR’ or values or terms such as ‘P-MPRc” or “P-MPR_{f,c}” or “P-MPR_{f,c,k}” may be used interchangeably, e.g., for referencing of a power management maximum power reduction value or term with respect to a carrier f or with respect to a serving cell c or with respect to an indicated joint/UL TCI state k. The term P-MPR may be used to exemplify certain embodiments wherein another maximum power reduction term such as an A-MPR may be applied. For example, P-MPR may be used by the UE for ensuring compliance with applicable electromagnetic energy absorption requirements such as MPE or for addressing unwanted emissions or self-de-sense requirements in case of simultaneous transmissions on multiple radio access technologies (RAT(s)) or when proximity detection is used to address such requirements that would require a lower maximum output power. For example, the UE may support a maximum output power according to a default or a supported UE Power Class. For example, the UE may be indicated or provided by higher layers with a value for a maximum output power using a parameter p-Max corresponding to a same or a lower value than provided by a default or a supported UE Power Class. For example, the UE may apply a maximum power reduction such as P-MPR with respect to a maximum output power according to a default or to a supported UE Power Class to determine a UE configured maximum output power or a configured transmitted power. For example, the term “MPR based mitigation behavior” is used as a short form by examples for P-MPR based power management; however, “MPR based mitigation behavior” can be applied with respect to other terms which may reduce or increase, adjust or limit, or provide a range, or a power level with respect to a maximum output power or a configured output power on a carrier or with respect to carriers in a band or in a band combination.

In certain embodiments, the UE may indicate or report to the gNB a supported UE Power Class such as defined in REFS7-9 defining a maximum output power for any transmission bandwidth within the channel bandwidth of an NR carrier for FR1 or defining a maximum output power radiated by the UE for any transmission bandwidth within the channel bandwidth for FR2.

For example, a UE Power Class for FR3 may be defined according to FR1 for operating frequencies in the range of 7-8 GHz. For example, a UE Power Class for FR3 may be defined according to FR2 for operating frequencies in the range of 14-15 GHz. For example, the UE operating in FR2 may indicate or report to the gNB a maximum output power according to power class 3 (PC3) corresponding to an assumed UE type “Handheld UE” or a power class 1 (PC1) corresponding to an assumed UE type “Fixed Wireless Access” UE where a UE power class may correspond to a set of associated performance requirements such as a minimum peak EIRP, or a maximum TRP, or a maximum EIRP, or a UE spherical coverage requirement.

In one embodiment the UE determines a first P-MPR value associated with UL transmissions corresponding to 5G/NR radio access in a first FR2 band and a second P-MPR value associated with UL transmissions corresponding to 6G radio access in a second FR2 band, respectively, for a band combination. For example, the first band may correspond to band n257 (26-29 GHz), and the second band may correspond to n260 (37-40 GHz).

In one embodiment the UE determines a first P-MPR value associated with UL transmissions corresponding to 6G radio access in a first FR2 band and a second P-MPR value associated with UL transmissions corresponding to 6G radio access in a second FR2 band, respectively, for a band combination. For example, the first band may correspond to band n257 (26-29 GHz), and the second band may correspond to n260 (37-40 GHz).

In a variant, the UE determines a first P-MPR value associated with UL transmissions corresponding to 5G/NR radio access in a first FR1 band and a second P-MPR value associated with UL transmissions corresponding to 6G radio access in a second FR1 band, respectively, for a band combination. For example, the first band may correspond to band n41 (2.6 GHz), and the second band may correspond to the FR1 4 GHz band.

In a variant, the UE determines a first P-MPR value associated with UL transmissions corresponding to 6G radio access in a first FR1 band and a second P-MPR value associated with UL transmissions corresponding to 6G radio access in a second FR1 band, respectively, for a band combination. For example, the first band may correspond to band n41 (2.6 GHz), and the second band may correspond to the FR1 4 GHz band.

In a variant, the UE determines a first P-MPR value associated with UL transmissions corresponding to 5G/NR radio access in a first FR1 band and a second P-MPR value associated with UL transmissions corresponding to 6G radio access in a second FR3 band, respectively, for a band combination. For example, the first band may correspond to band n41 (2.6 GHz), and the second band may correspond to the FR3 7-8 GHz band.

In a variant, the UE determines a first P-MPR value associated with UL transmissions corresponding to 6G radio access in a first FR1 band and a second P-MPR value associated with UL transmissions corresponding to 6G radio access in a second FR3 band, respectively, for a band combination. For example, the first band may correspond to band n41 (2.6 GHz), and the second band may correspond to the FR3 7-8 GHz band.

In a variant, the UE determines a first P-MPR value associated with UL transmissions corresponding to 5G/NR radio access in a first FR2 band and a second P-MPR value associated with UL transmissions corresponding to 6G radio access in a second FR3 band, respectively, for a band combination. For example, the first band may correspond to band n257 (26-29 GHz), and the second band may correspond to the FR3 14-15 GHz band.

In a variant, the UE determines a first P-MPR value associated with UL transmissions corresponding to 6G radio access in a first FR2 band and a second P-MPR value associated with UL transmissions corresponding to 6G radio access in a second FR3 band, respectively, for a band combination. For example, the first band may correspond to band n257 (26-29 GHz), and the second band may correspond to the FR3 14-15 GHz band. Separately determined P-MPR values with respect to a first carrier or band and a second carrier or band, or with respect to 5G/NR radio access and 6G/NR radio access, e.g., a first P-MPR value and a second P-MPR value, may correspond to a same or to different UE power classes. For example, a UE may determine a first P-MPR value for FR2 corresponding to FR2 PC3 and a second P-MPR value for FR3 7-8 GHz corresponding to an FR3 PC2. For example, a first P-MPR value for FR1 in a band such as below 3 GHz and a second supported P-MPR value for FR1 in the 4 GHz band may both correspond to FR1 PC2. For example, the UE may determine a first P-MPR value for FR1 or FR2 with respect to the first carrier or band, or with respect to 5G/NR radio access on a carrier or in a band and a second P-MPR value with respect to the second carrier or band, or with respect to 6G radio access on the carrier or the band.

A first and a second P-MPR value may correspond to a same radio access type or may correspond to different radio access types wherein a radio access type may correspond to 4G/LTE radio access, or to 5G/NR radio access, or to 6G radio access. A same or a separate or a joint/common type of MPR mitigation behavior can be applied by the UE on a carrier or in a band of a band combination as further described by the embodiments. An allowable or supported value, or limit, or range with respect to a first or a second P-MPR value associated with UL transmissions in a first carrier or band such as based on 5G/NR or 6G radio access and in a second carrier or band such as based on 6G radio access, respectively, in a band combination comprising a carrier from an FR1, or FR2, or FR3 band may be indicated and reported by the UE to the gNB, or provided by the gNB to the UE, or may be indicated or tabulated by system operating specifications as further described in the embodiments.

An operational use such as an allowable or a supported value, or limit, or range with respect to a first or a second P-MPR value associated with UL transmissions in a first carrier or band and a second carrier or band by the UE, respectively, in a band combination, wherein one of the bands corresponds to 6G radio access may be further associated or be subject to conditions or restrictions as described by the embodiments.

A P-MPR value for a band in a band combination for 5G/NR or 6G radio access and for 6G radio access, respectively, e.g., a first and a second P-MPR value, may be indicated or reported to the gNB separately, e.g., based on separate information fields, values, or an index representative thereof, or jointly, e.g., based on a combined information field, value or set, or an index representative thereof.

A P-MPR value for a UE supporting 6G radio access in a band of a band combination may correspond to a default P-MPR value, e.g., corresponding to a set of assumed system operating conditions. For example, a default P-MPR value for a first carrier or band corresponding to 5G/NR or 6G radio access and a second carrier or band corresponding to 6G radio access, respectively, in a band combination, may be same or correspond to different default P-MPR values. For example, a default P-MPR value in the carrier or the band for 5G/NR or 6G radio access and for 6G radio access, respectively, or for a first carrier or band and a second carrier or band, respectively, wherein one of the bands corresponds to 6G radio access may be provided to the UE by the gNB using higher layer signaling or may be indicated or reported by the UE to the gNB as a value or a setting using UE radio access capability parameters.

A first or a second P-MPR value associated with UL transmissions on a carrier corresponding to 6G radio access may be separately determined or indicated for the carrier in the band when a serving cell on the carrier is indicated for single carrier operation, or for a carrier in a band of a band combination associated with carrier aggregation, or with dual connectivity operation, or with dual active protocol stack operation.

In one example, the UE determines a first supported P-MPR value associated with UL transmissions on a carrier in a band when a serving cell is indicated for 6G radio access and the UE determines a second supported P-MPR value on the carrier in the band when the serving cell is indicated as part of a band combination for carrier aggregation operation or for dual connectivity operation, or for dual active protocol stack operation.

For example, a UE may determine a first supported P-MPR value for a carrier in an FR2 band when the serving cell using 6G radio access is indicated for single carrier operation and the UE determines a second P-MPR value when the serving cell is indicated as part of a band combination for carrier aggregation or for dual connectivity or for dual active protocol stack operation such as in a band combination within FR2 or across FR1 and FR2.

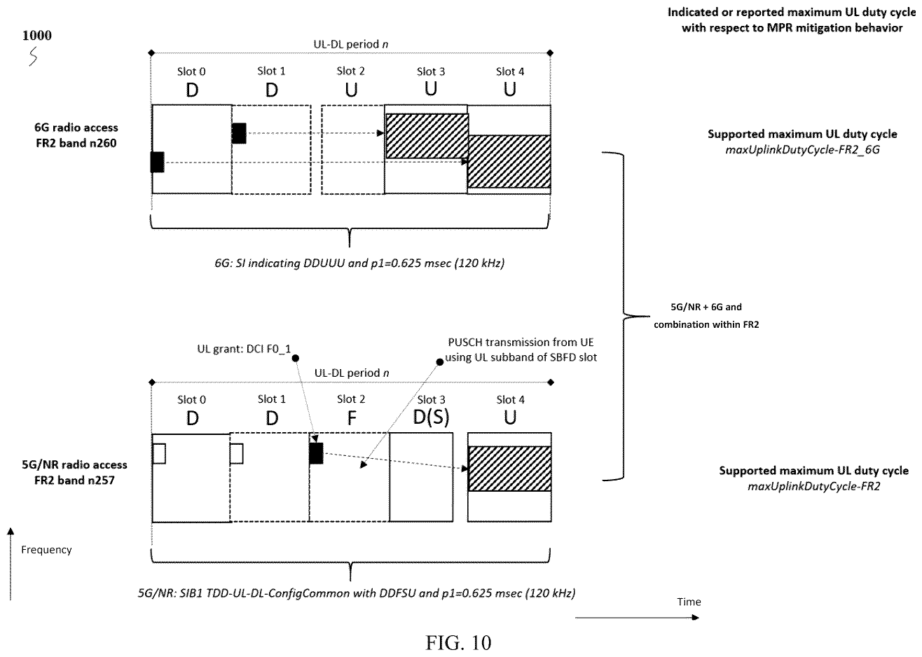

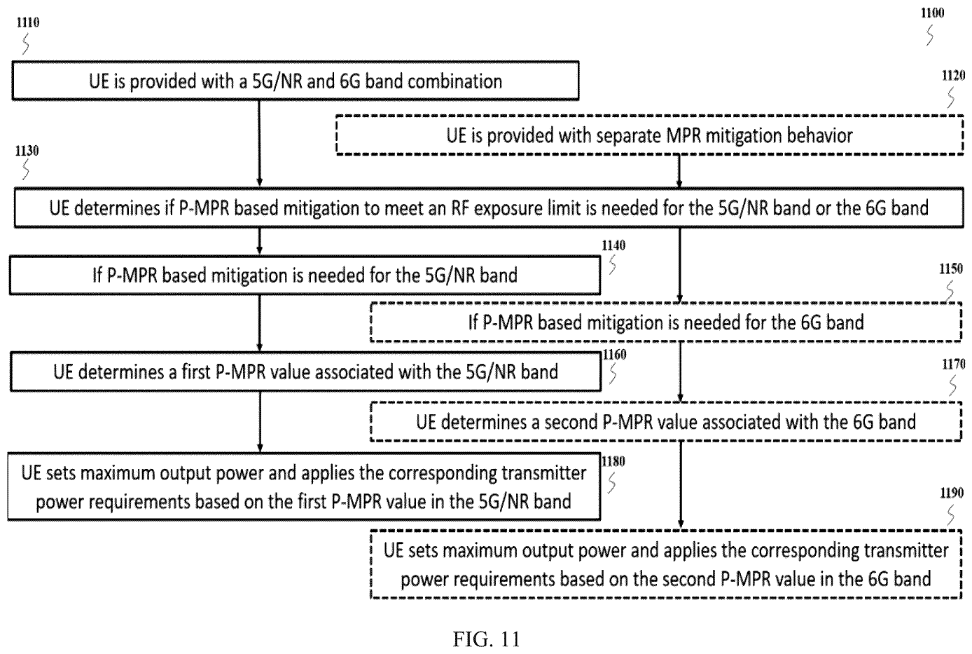

FIG. 10 illustrates an example timeline 1000 of a separate P-MPR based mitigation behavior in a first and a second band of a band combination for a wireless communication system according to embodiments of the present disclosure. The timeline 1000 of FIG. 10 can be utilized or followed by any of the UEs 111-111 of FIG. 1, such as the UE 111 of FIG. 3, and any of the BSs 101-103 of FIG. 1, such as BS 102 of FIG. 2. The timeline 1000 is for illustration only and other embodiments can be used without departing from the scope of the present disclosure.

In one example and with reference to FIG. 10, the UE determines a separate P-MPR value associated with UL transmissions in a first band corresponding to 5G/NR radio access in FR2 and in a second band corresponding to 6G radio access in FR2, respectively, in a band combination. For simplicity of description and illustration purposes and without loss of generality, the example of a UE on a first carrier corresponding to 5G/NR radio access using FR2 NR band n257 (26-29 GHz) and on a second carrier corresponding to 6G radio access in the FR2 band n260 (37-40 GHz) is considered.

In this example, the UE indicates or reports a supported FR2 UE Power Class, i.e., FR2 PC3, to the gNB as the power class the UE supports for the UL transmissions in an FR2 band using a parameter ue-PowerClass in the UE radio access capability parameters. For the power class, the UE may indicate or report to the gNB an associated supported maximum UL duty cycle. For example, the UE may indicate or report to the gNB its associated supported maximum UL duty cycle as the maximum percentage of symbols during a certain evaluation period that can be scheduled for UL transmission to ensure compliance with applicable electromagnetic energy absorption requirements provided by regulatory bodies. For example, the UE may report a supported maximum UL duty cycle associated with 5G/NR radio access using a parameter maxUplinkDutyCycle-FR2 as part of the signaled UE radio access capability parameters. For example, the UE may indicate a value n25, or 25%, as supported maximum UL duty cycle associated with the 5G/NR radio access in FR2 band n257. For example, the UE may report a supported maximum UL duty cycle associated with 6G radio access using a parameter maxUplinkDutyCycle-FR2 6G as part of the signaled UE radio access capability parameters. For example, the UE may indicate a value n30, or 30%, as supported maximum UL duty cycle associated with the 6G radio access in FR2 band n260.

In the example, the UE may determine separate P-MPR values to determine a UE maximum output power associated with UL transmissions corresponding to 5G/NR radio access in the FR2 band n257 and with UL transmissions corresponding to 6G radio access in the FR2 band n260, respectively, in the band combination based on a separate UL duty cycle evaluation behavior. For example, the UE may compare a value determined for the first UL duty cycle in the FR2 5G/NR band, e.g., X_{5G}=20%, in a certain evaluation period to a first threshold value, e.g., X_{5G, TH}=25%. For example, the UE may compare a value determined for the second UL duty cycle, e.g., X_{6G}=40%, in a certain evaluation period to a second threshold value, e.g., X_{6G, TH}=30%. The first and the second threshold values may be a same value or correspond to different values. For example, when the value of an UL duty cycle is higher than a threshold value, the UE may apply P-MPR to determine a configured UE maximum output power P_{CMAX,f,c} and when the value of an UL duty cycle is smaller than and/or equal to a threshold value the UE may not apply P-MPR to determine P_{CMAX,f,c}. In the example, for the values X_{5G}=20%, X_{5G, TH}=25%, X_{6G}=40% and X_{6G, TH}=30%, the UE may then apply P-MPR in the FR2 6G band to reduce the maximum output power for a later UL transmission in the FR2 band n260 using MPR based mitigation and may not apply P-MPR in the FR2 5G/NR band when determining a maximum output power and/or applying the corresponding transmitter power requirements.

Similar considerations based on the example can be applied to other cases such as other FR1 or FR2 or FR3 UE Power Classes such as FR2 PC1 or FR1 PC2, or to other cases such as when the UE operates 5G/NR radio access and 6G radio access in a same frequency range such as within FR1, or within FR2, or within FR3, or to other cases such as when the UE operates 5G/NR radio access and 6G radio access across frequency ranges such as FR1 and FR2, or across FR2 and FR3, or to other cases such as when the UE operates 4G/LTE radio access instead of 5G/NR radio access with 6G radio access, or to other cases such as when the UE operates 6G radio access on the carriers or bands within a same or across frequency ranges.

A motivation is that support for separate determination of P-MPR values by a UE for an FR2 band using 5G/NR or 6G radio access and an FR2 band using 6G radio access in a band combination by a UE can enable separate control and adjustment of the UE maximum output power, for example using MPR based mitigation behavior when a maximum or a default UL duty cycle value is exceeded during UL transmission in the 5G/NR or 6G band and in the 6G band of the band combination, respectively. This can benefit the achievable UL coverage or the UL data rate or the UL link robustness of a UE supporting 6G radio access.

For example, when UL transmissions for the UE are preferably scheduled or configured by the gNB in the FR2 6G band n260 where less interference may be incurred due to a reduced loading or where lower target receive power settings may be employed than in the FR2 5G/NR band n257, it may be preferable to not reduce the UE maximum output power in the FR2 6G band and rather first apply MPR based mitigation behavior, if needed, to the FR2 5G/NR band. One reason is that more SINR per slot/symbol may be collected by the gNB using 6G radio access due to improved processing gains. If the UE reduces a maximum output power using MPR based mitigation, for example to comply with electromagnetic energy absorption requirements, the maximum output power in the FR2 6G band n260 band should preferably be reduced last. An UL coverage or an UL throughput or UL link robustness for the UE can then be improved in the 6G band. Existing technology would reduce the UE maximum output power in both bands of the band combination unpredictably and depending on a UE implementation which is undesirable.

In another example, it may be more advantageous to use the supported UE maximum output power according to the FR2 UE PC for UL transmissions from the UE on the carrier in the FR2 5G/NR lower band such as when PUSCH repetition in the FR2 5G/NR lower band is configured for a UE at cell edge or in lower SINR operating conditions. When a UE maximum output power is reduced by the UE according to MPR based mitigation behavior for the FR2 band combination, for example to comply with electromagnetic energy absorption requirements, it may be preferable to maintain the supported UE maximum output power for the FR2 5G/NR lower band providing UL coverage, and then separately adjust or reduce a UE maximum output power for the FR2 6G higher band used as capacity booster where the use an P-MPR value to reduce the maximum output power in the band may result in reduced impact, for example when the gNBs or TRPs are not co-located.

Using existing technology for UEs based on carrier aggregation or dual connectivity operation, for example the gNB or TRP may attempt to reduce UL scheduling activity on the FR2 6G higher band in the band combination for the UE, to reduce its contribution to the UL duty cycle such that UE behavior with respect to an available maximum output power in the FR2 5G/NR band is dominated by the contribution of UL scheduling in the FR2 5G/NR band to the UL duty cycle, but the UE autonomous behavior in existing technology with respect to determination of a maximum output power by the UE for an UL transmission instance in a period may still not be accurately known or predicted by the gNB for periods of several seconds or more. P-MPR based mitigation using existing technology can result in radio link interruption due to lower than required UL transmission power in the FR2 5G/NR band which is undesirable. For UEs supporting 6G radio access, such scheduling coordination between the 5G/NR radio access network function and the 6G radio access network function to reduce an UL duty cycle in the 6G band may not be possible for the radio access network. One example is CA based operation where the schedulers may operate independently among cells and may not be assumed to communicate without delay.

In one embodiment the UE is provided with an MPR mitigation behavior to apply for a first and a second carrier or band, respectively, of a band combination, wherein a provided MPR mitigation behavior may correspond to a same, or a separate or a separate joint/common type of MPR mitigation behavior to apply with respect to the first and/or the second carrier or band of the band combination. For example, an MPR may correspond to a P-MPR.

For example, an MPR mitigation behavior corresponding to the first or the second carrier or band may be provided or indicated to the UE by the gNB based on one of or a combination of DCI-based signaling, L1 control signaling, RRC signaling, or MAC CE signaling, or NAS based signaling. For example, an MPR mitigation behavior corresponding to the first or the second carrier or band may be provided by system operating specifications. For example, an MPR mitigation behavior corresponding to the first or the second carrier or band may be selected by the UE according to a condition. For example, based on the indication from the gNB, the UE determines the MPR mitigation behavior for a later UL transmission for the first or the second carrier or band, respectively, of the band combination.

In one example, the UE is provided with an MPR mitigation behavior to apply for a first carrier corresponding to 5G/NR or 6G radio access in a first FR2 band and a second carrier corresponding to 6G radio access in a second FR2 band of a band combination. For example, the first band may correspond to band n257 (26-29 GHz), and the second band may correspond to n260 (37-40 GHz).

In one example, the UE is provided with an MPR mitigation behavior to apply for a first carrier corresponding to 5G/NR or 6G radio access in a first FR1 band and a second carrier corresponding to 6G radio access in a second FR1 band of a band combination. For example, the first band may correspond to band n41 (2.6 GHz), and the second band may correspond to the FR1 4 GHz band.

In one example, the UE is provided with an MPR mitigation behavior to apply for a first carrier corresponding to 5G/NR or 6G radio access in a first FR1 band and a second carrier corresponding to 6G radio access in a second FR3 band of a band combination. For example, the first band may correspond to band n41 (2.6 GHz), and the second band may correspond to the FR3 7-8 GHz band.

In one example, the UE is provided with an MPR mitigation behavior to apply for a first carrier corresponding to 5G/NR or 6G radio access in a first FR2 band and a second carrier corresponding to 6G radio access in a second FR3 band of a band combination. For example, the first band may correspond to band n257 (26-29 GHz), and the second band may correspond to the FR3 14-15 GHz band.

A motivation for a provided MPR mitigation behavior (or MPR mitigation mode), is that separate control and adjustment of the UE maximum output power with respect to UL transmission in the first 5G/NR or 6G band and the second 6G band of the band combination can be selected by the network according to the needs of the deployment. For example, a same MPR mitigation behavior by the UE supporting 6G radio access may be preferred when 5G/NR or 6G radio access on the first carrier and 6G radio access on the second carrier operate in close bands and a same UL RF front-end may be used, e.g., within FR2, or when operating according to carrier aggregation. For example, a separate MPR mitigation behavior by the UE supporting 6G radio access may be preferred when 5G/NR or 6G radio access on the first carrier and 6G radio access on the second carrier operate in wider separated bands where separate UL RF front-ends may be used, e.g., across FR1 and FR3, or where gNB scheduling with respect to an MCG and SCG may operate without exchange of real-time scheduling decisions. For example, a joint or common MPR mitigation behavior by the UE supporting 6G radio access may be preferred when gNB scheduling with respect to 5G/NR or 6G radio access on the first carrier and 6G radio access on the second carrier may operate without exchange of real-time scheduling decisions, an UL duty cycle with respect to MCG scheduling may be estimated by a gNB, and a potential impact on a total UE maximum output power from separate SCG scheduling may be bounded or estimated by the MCG scheduling based on an assumed or scaled or maximum P-MPR value with respect to the SCG scheduling.

For example, an MPR mitigation behavior can be applied with respect to a same UE Power Class or with respect to a first and a second supported UE Power Class for UL transmissions in a first carrier or band and a second carrier or band, respectively, of the band combination. When a first and a second UE Power Class is supported by a UE for the band combination, the first and the second UE Power Class may correspond to a same power class or may correspond to different power classes for a FR or may correspond to different power class types such as corresponding to those defined for different frequency ranges. For example, a same supported UE Power Class such as FR1 PC2, or 26 dBm, for a band combination may be indicated and/or reported by a UE which operates in FR1, or which operates across FR1 and FR3 7-8 GHz wherein it is assumed that an FR3 UE PC for the 6G 7-8 GHz band is defined FR1-like. For example, separate supported UE Power Classes such as FR1 PC2, or 26 dBm, for FR1 and FR3 PC3, or 23 dBm, for the FR3 7-8 GHz band of a band combination may be indicated and/or reported by a UE for the band combination across FR1 and FR3 7-8 GHz. For example, separate supported UE Power Class types such as FR1 PC3, or 23 dBm, for the FR1 band and FR2 PC3 corresponding to Handheld UE for the FR2 band of a band combination may be indicated and/or reported by a UE for the band combination across FR1 and FR2.

For the cases where a same or a separate or a joint/common MPR mitigation behavior is applied by the UE to further determine a maximum output power, or a first and a second selected or applied P-MPR value; an P-MPR value may be determined based on an UL duty cycle associated with UL transmissions in the bands, or based on a first UL duty cycle or a second UL duty cycle, respectively, wherein the first and/or the second UL duty cycle may be associated with UL transmissions on a first band and a second band, respectively.

When a same MPR mitigation behavior is applied by the UE to further determine a maximum output power and/or apply the corresponding transmitter power requirements, the UE determines a P-MPR value associated with UL transmissions in a first carrier or band corresponding to 5G/NR or 6G radio access or in a second carrier or band corresponding or 6G radio access to set an UL transmitter power based on the P-MPR value.

When a separate MPR mitigation behavior is applied by the UE, the UE determines a first P-MPR value with respect to the first carrier or band in the band combination, and the UE determines a second P-MPR value with respect to the second carrier or band in the band combination. The UE then further determines a maximum output power and/or applies the corresponding transmitter power requirements according to the first P-MPR value and the second P-MPR value to set an UL transmitter power for UL transmissions in the first carrier or band and in the second carrier or band, respectively, of the band combination.

For example, when the UE supports FR1 PC1.5 in an FR1 5G/NR or 6G band and FR1 PC2 in a FR1 6G band 4 GHz, the gNB may provide/indicate the UE with a separate MPR mitigation behavior (or MPR mitigation mode). For example, the gNB may indicate to the UE to select a first actual P-MPR value from a first set S_{5G} or first set S_{6G1} of possible P-MPR values for the 5G/NR or 6G band and to select a second actual P-MPR value from a second set S_{6G2} of possible P-MPR values for the 6G band, respectively, in the band combination. For example, the gNB may indicate to the UE to select a first and a second P-MPR value for the 5G/NR band and/or the 6G band, respectively, from a same set S_{5G}=S_{6G2} of provided possible P-MPR values.

FIG. 11 illustrates an example flowchart for a process 1100 of a separate P-MPR based mitigation behavior in a first and a second band of a band combination for a wireless communication system according to embodiments of the present disclosure. The process 1100 of FIG. 11 can be performed by any of the UEs 111-111 of FIG. 1, such as the UE 111 of FIG. 3, and a corresponding method can be performed by any of the BSs 101-103 of FIG. 1, such as BS 102 of FIG. 2. The process 1100 is for illustration only and other embodiments can be used without departing from the scope of the present disclosure.

The process 1100 begins with the UE being provided with a 5G/NR and 6G band combination (1110). The UE is provided with common MPR mitigation behavior (1120). The UE determines if P-MPR based mitigation to meet an RF exposure limit is needed for the 5G/NR band or the 6G band (1130). If P-MPR based mitigation is needed for the 5G/NR band (1140), the UE determines a first P-MPR value associated with the 5G/NR band (1160). If P-MPR based mitigation is needed for the 6G band (1150), the UE determines a second P-MPR value associated with the 6G band (1170). The UE sets maximum output power and applies the corresponding transmitter power requirements based on the first P-MPR value in the 5G/NR band (1180). The UE sets maximum output power and applies the corresponding transmitter power requirements based on the second P-MPR value in the 6G band (1190).

When a joint or common MPR mitigation behavior is applied by the UE, the UE determines a first P-MPR value with respect to the first carrier or band in the band combination, and/or the UE determines a second P-MPR value with respect to the second carrier or band in the band combination. The UE then further determines an applied first P-MPR value and/or an applied second P-MPR value based on the first and/or the second P-MPR value. The applied first and second P-MPR values may correspond to one resulting value or to separate resulting values. Using the applied first and second P-MPR values, the UE then further determines a maximum output power and/or applies the corresponding transmitter power requirements to set an UL transmitter power for UL transmissions in the first carrier or band and in the second carrier or band, respectively, of the band combination. For example, when the UE determines a first P-MPR value for the FR1 5G/NR or 6G band and a second P-MPR value for the FR3 6G band, the UE may further select the first P-MPR value corresponding to the lower FR1 5G/NR or 6G band as resulting value for the P-MPR according to a joint or common MPR mitigation behavior for the band combination.

In one example, when the UE supports FR2 PC3 and operates in a first FR2 band such as n257 using 5G/NR or 6G radio access and in a second FR2 band such as n260 using 6G radio access in a band combination, the UE may be provided with a separate MPR mitigation behavior (or MPR mitigation mode). For example, the gNB may indicate to the UE to apply up to a maximum P-MPR value P-MPR_{MAX,5G} for the 5G/NR (or a maximum P-MPR value P-MPR_{MAX,6G1}) for the 6G band and/or to apply a separate up to a maximum P-MPR value P-MPR_{MAX,6G2} for the 6G band, respectively. For example, the gNB may indicate to the UE to apply up to a maximum P-MPR value P-MPR_{MAX,5G} or P-MPR_{MAX,6G1} for the 5G/NR or 6G band and to apply up to a same maximum P-MPR value P-MPR_{MAX,6G2}=P-MPR_{MAX,5G} for the 6G band, respectively. For example, the gNB may indicate to the UE to apply an actual P-MPR value P-MPR_{5G} from a first set S_{5G} of possible P-MPR values such as S_{5G}={0, −4, −8, −12}dB in the 5G/NR band and/or to apply a separate actual P-MPR value P-MPR_{6G2} from a second set S_{6G2} of possible P-MPR values such as S_{6G2}={0, −2, −4} dB in the 6G band, respectively. Note that the examples for an actual or nominal P-MPR value and/or a set of possible P-MPR values were chosen for simplicity and illustration purposes. For example, an indicated or a reported value for a P-MPR or power headroom reporting quantity may employ index-based mapping and/or mapping with respect to a value range for a label according to details provided by REF8.

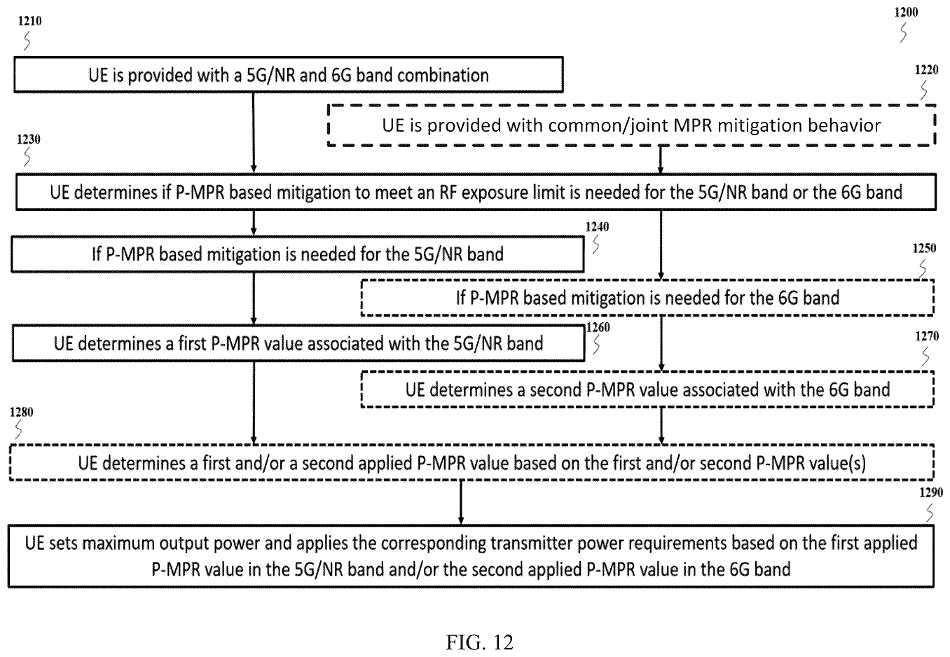

FIG. 12 illustrates an example flowchart for a process 1200 of a joint/common P-MPR based mitigation behavior in a first and a second band of a band combination to determine an UL maximum output power for a wireless communication system according to embodiments of the present disclosure. The process 1200 of FIG. 12 can be performed by any of the UEs 111-111 of FIG. 1, such as the UE 111 of FIG. 3, and a corresponding method can be performed by any of the BSs 101-103 of FIG. 1, such as BS 102 of FIG. 2. The process 1200 is for illustration only and other embodiments can be used without departing from the scope of the present disclosure.

The process 1200 begins with the UE being provided with a 5G/NR and 6G band combination (1210). The UE is provided with common/joint MPR mitigation behavior (1220). The UE determines if P-MPR based mitigation to meet an RF exposure limit is needed for the SG/NR band or the 6G band (1230). If P-MPR based mitigation is needed for the 5G/NR band (1240), the UE determines a first P-MPR value associated with the 5G/NR band (1260). If P-MPR based mitigation is needed for the 6G band (1250), the UE determines a second P-MPR value associated with the 6G band (1270). The UE determines a first and/or a second applied P-MPR value based on the first and/or second P-MPR value(s) (1280). The UE sets maximum output power and applies the corresponding transmitter power requirements based on the first applied P-MPR value in the 5G/NR band and/or the second applied P-MPR value in the 6G band (1290).

When a separate or a joint/common MPR mitigation behavior is applied by the UE, the UE may determine an applied P-MPR value based on the first and the second P-MPR value using an adjustment factor. For example, the UE may determine a second, i.e., assumed or equivalent, P-MPR value based on a first P-MPR value and an adjustment factor. The UE then further determines a maximum output power and/or applies the corresponding transmitter power requirements using the assumed or equivalent P-MPR value in a band corresponding to 5G/NR or 6G radio access or corresponding to 6G radio access of the band combination. For example, an adjustment factor may be provided to the UE. For example, an adjustment factor may correspond to a scaling factor, or a weighting factor, or an offset value, or an averaging, or a determination of a maximum or a minimum value, or an application of a threshold value with respect to a first or a second P-MPR value or a type of UL transmissions in a carrier in a band.

In one example for a separate or joint/common MPR mitigation behavior based on an adjustment factor, the UE determines a first and a second P-MPR value corresponding to UL transmissions in the first 5G/NR or 6G carrier or band and in the second 6G carrier or band of the band combination, respectively. For example, when transmitting an UL signal or channel in the FR1 carrier or band of the band combination, the UE counts the UL transmission with respect to a first UL duty cycle associated with UL transmissions corresponding to 5G/NR or 6G radio access but does not count the UL transmission with respect to a second UL duty cycle associated with UL transmissions corresponding to 6G radio access in the FR3 carrier or band. When transmitting an UL signal or channel in the FR3 carrier or band of the band combination, the UE counts the UL transmission with respect to the second UL duty cycle associated with UL transmissions corresponding to 6G radio access but does not count the UL transmission with respect to the first UL duty cycle associated with UL transmissions corresponding to 5G/NR or 6G radio access in the FR1 carrier or band. For example, the UE may determine a value for the first UL duty cycle as X_{FR1}=60% corresponding to 5G/NR or 6G radio access in an evaluation period and a value for the second UL duty cycle as X_{FR3}=30% corresponding to 6G radio access in an evaluation period and determine a first corresponding P-MPR_{FR1}=3 dB value and a second corresponding P-MPR_{FR3}=12 dB value if the first and the second UL duty cycles are separately evaluated. The UE may determine an effective P-MPR value for the band combination as P-MPR_{eff} as a weighted linear average of the values P-MPR_{FR1} and P-MPR_{FR3}. Based on the effective P-MPR value, the UE may further determine a maximum output power and/or apply the corresponding transmitter power requirements to set an UL transmitter power for UL transmissions in the first band corresponding to 5G/NR or 6G radio access and/or the second band corresponding to 6G radio access, respectively.

In another example for a separate or joint/common MPR mitigation behavior based on an adjustment factor, the UE determines a first or a second P-MPR value corresponding to UL transmissions in the first 5G/NR or 6G carrier or band and in the second 6G carrier or band of the band combination, respectively, using a scaling factor. For example, the UE may determine a first P-MPR value corresponding to UL transmissions in the FR2 band corresponding to 5G/NR or 6G radio access. For example, when the UE determines a first P-MPR value as P-MPR_{5G}=6 dB or P-MPR_{6G1}=6 dB corresponding to 5G/NR or 6G radio access, the UE then applies a provided scaling factor X_{SCALE}=0.5 to determine a second P-MPR value as effective P-MPR value in the FR2 band corresponding to 6G radio access of the band combination as (linear) P-MPR_{6G,eff}=X_{SCALE}*P-MPR_{5G} or P-MPR_{6G,eff}=X_{SCALE}*P-MPR_{6G1}. Based on the effective P-MPR value, the UE may further determine a maximum output power and/or apply the corresponding transmitter power requirements to set an UL transmitter power for UL transmissions in the second FR2 band corresponding to 6G radio access.

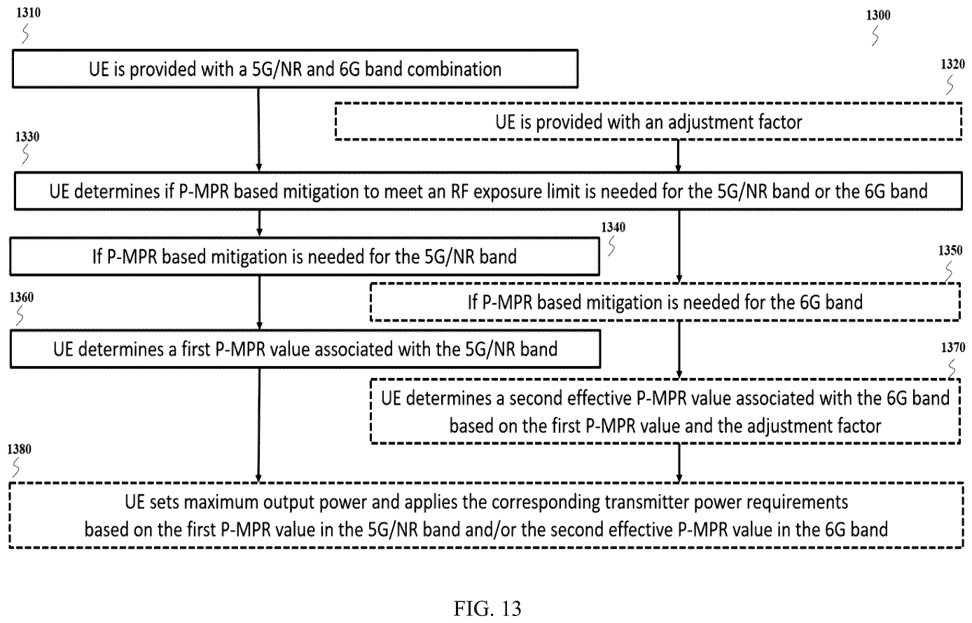

FIG. 13 illustrates an example flowchart for a process 1300 of a P-MPR based mitigation using an adjustment factor in a band combination for a wireless communication system according to embodiments of the present disclosure. The process 1300 of FIG. 13 can be performed by any of the UEs 111-111 of FIG. 1, such as the UE 111 of FIG. 3, and a corresponding method can be performed by any of the BSs 101-103 of FIG. 1, such as BS 102 of FIG. 2. The process 1300 is for illustration only and other embodiments can be used without departing from the scope of the present disclosure.

The process 1300 begins with the UE being provided with a 5G/NR and 6G band combination (1310). The UE is provided with an adjustment factor (1320). The UE determines if P-MPR based mitigation to meet an RF exposure limit is needed for the 5G/NR band or the 6G band (1330). If P-MPR based mitigation is needed for the 5G/NR band (1340), the UE determines a first P-MPR value associated with the 5G/NR band (1360). If P-MPR based mitigation is needed for the 6G band (1350), the UE determines a second effective P-MPR value associated with the 6G band based on the first P-MPR value and the adjustment factor (1370). The UE sets maximum output power and applies the corresponding transmitter power requirements based on the first P-MPR value in the 5G/NR band and/or the second effective P-MPR value in the 6G band (1380).

In another example for a separate or joint/common MPR mitigation behavior based on an adjustment factor, the UE determines a first and a second UL duty cycle corresponding to UL transmissions in the first 5G/NR or 6G carrier or band and in the second 6G carrier or band, respectively. For example, the UE counts the UL transmission with respect to the first UL duty cycle associated with UL transmissions in a first FR2 band corresponding to 5G/NR or 6G radio access but does not count the UL transmission with respect to the second UL duty cycle associated with UL transmissions in a second FR2 band corresponding to 6G radio access. For example, the UE counts the UL transmission with respect to the second UL duty cycle associated with UL transmissions in a second FR2 band corresponding to 6G radio access but does not count the UL transmission with respect to the first UL duty cycle associated with UL transmissions in the first FR2 band corresponding to 5G/NR or 6G radio access. Based on the first or second UL duty cycle values, the UE may determine a first or a second P-MPR value for the 5G/NR or 6G carrier or band or the 6G carrier or band, respectively, of the band combination. For example, when transmitting an UL signal or channel in the first FR2 band corresponding to 5G/NR or 6G radio access, the UE applies the first P-MPR value to any UL transmission in a period. The UE may determine a second effective P-MPR value for the 6G carrier or band of the band combination with respect to a threshold value. For example, the UE applies the second P-MPR value when an UL transmission in the second FR2 carrier or band corresponds to more than a value TH of time-domain symbols, and does not apply the second P-MPR value when an UL transmission in the second FR2 carrier or band is equal or less than TH symbols. A motivation is that SRS transmissions of 1 or 2 symbol duration in the second carrier or band corresponding to 6G radio access may then be transmitted without incurring an UL link budget penalty when P-MPR based mitigation is applied to determine a maximum output power.

Similar considerations based on the example can be applied to other cases such as other FR1 or FR2 or FR3 UE Power Classes such as FR2 PC1 or FR1 PC2, or to other cases such as when the UE operates 5G/NR radio access and 6G radio access in a same frequency range such as within FR1, or within FR2, or within FR3, or to other cases such as when the UE operates 5G/NR radio access and 6G radio access across frequency ranges such as FR1 and FR2, or across FR2 and FR3, or to other cases such as when the UEs operates 4G/LTE radio access instead of 5G/NR radio access with 6G radio access, or to other cases such when the UE operates 6G radio access on a first and a second carrier within a frequency range or across frequency ranges

In one embodiment the UE is provided with information for an MPR mitigation behavior to apply for a first or a second carrier or band, respectively, in a band combination wherein the MPR based mitigation behavior corresponds to a desired, or a preferred, or an allowed, or an enabled, or a requested, or a prioritized carrier or band on which to apply the P-MPR based mitigation. Based on the provided information, the UE determines the MPR mitigation behavior and/or a value for P-MPR based mitigation for a later UL transmission in the first carrier or band or in the second carrier or band, respectively, in the band combination.

For example, an MPR mitigation behavior corresponding to a desired, or a preferred, or an allowed, or an enabled, or a requested, or a prioritized carrier or band may be provided or indicated to the UE by the gNB based on one of or a combination of DCI-based signaling, L1 control signaling, RRC signaling, or MAC CE signaling, or NAS based signaling. For example, an MPR mitigation behavior corresponding to the first or the second carrier or band may be provided by system operating specifications. For example, an MPR mitigation behavior corresponding to the first or the second carrier or band may be selected by the UE according to a condition.

In a variant, the MPR mitigation behavior or P-MPR based mitigation to apply for a first or a second carrier or band, respectively, in a band combination, may correspond to a sequence or a list providing a preference or order of carriers or bands according to which a P-MPR based mitigation may be applied first or last in the band combination.

For example, the MPR mitigation behavior or P-MPR based mitigation may correspond to an indication received by the UE from the gNB for a desired, or a preferred, or an allowed, or an enabled, or a requested, or a prioritized carrier or band in a band combination on which the P-MPR based mitigation should be applied. For example, a MPR mitigation behavior or P-MPR based mitigation may correspond to an indication received by the UE from the gNB for a not desired, or a not preferred, or a disallowed, or a disabled carrier or band on which the P-MPR based mitigation should not be applied. More than one desired, or preferred, or allowed, or enabled, or requested, or prioritized or more than one not desired, or not preferred, or disallowed, or disabled carrier or band with respect to the MPR based mitigation behavior or P-MPR based mitigation may be indicated to the UE, i.e., indicated as a set. When a set is indicated, and more than one carrier or band can be selected by the UE with respect to an MPR mitigation behavior, a suitable rule can be defined to determine a carrier or band from the set. For example, the UE may select the first carrier or band in a list or in a set for to apply P-MPR based mitigation.

In one example, when the UE receives an indication from the gNB wherein the indicated MPR mitigation behavior corresponds to P-MPR based mitigation for a requested carrier or band, the UE may apply the P-MPR based mitigation in the corresponding carrier or band to determine an UL transmission power, for example under certain conditions such as when a maximum UL duty cycle is exceeded, but the UE does not apply P-MPR based mitigation on a not indicated carrier or band.

In one example, when the UE receives an indication from the gNB wherein the indicated MPR mitigation behavior corresponds to a prioritized list or a set of carriers or bands, the UE selects a carrier or band from the list or the set to apply P-MPR based mitigation. For example, the UE may select a highest priority carrier or band in the band combination to apply P-MPR based mitigation, e.g., under certain conditions such as when a maximum UL duty cycle is exceeded, and the UE determines a P-MPR value with respect to UL transmission in the corresponding carrier or band of the band combination to further determine a maximum output power and/or apply the corresponding transmitter power requirements according to the prioritized list or the set of carriers or bands.

For example, an FR3 6G carrier or band may be set to high priority and an FR1 5G/NR or 6G carrier or band may be set to low priority. The UE then selects the higher priority carrier or band, i.e., corresponding to FR3 6G, to determine a P-MPR value and/or apply the MPR mitigation behavior in this band of the band combination. For example, the UE may then apply a P-MPR based mitigation to UL transmissions in the lower priority FR1 5G/NR or 6G carrier or band, e.g., under certain conditions such as when a number or a type of UL transmissions in the higher priority band to apply the P-MPR based mitigation is not sufficient.

As can be seen by someone skilled in the art, similar considerations can be applied to other cases such as when multiple priority levels associated with a default or indicated P-MPR based mitigation are provided, or to other cases such as when a high, or a medium or a low priority levels are used, or to other cases such as when a priority is provided from a value range, e.g., 1 corresponding to highest priority and 5 corresponding to a lowest priority, or equivalent.

In one embodiment the UE is provided with information for an MPR mitigation behavior or a P-MPR based mitigation to apply for a first or a second carrier or band in a band combination based on a condition wherein at least one carrier or band is indicated for 6G radio access.

For example, an MPR based mitigation behavior or P-MPR based mitigation associated with a condition may be provided or indicated to the UE by the gNB based on one of or a combination of DCI-based signaling, L1 control signaling, RRC signaling, or MAC CE signaling, or NAS based signaling. For example, an MPR mitigation behavior or P-MPR based mitigation corresponding to the first or the second carrier or band may be provided by system operating specifications. For example, an MPR mitigation behavior or P-MPR based mitigation behavior corresponding to the first or the second carrier or band may be determined by the UE according to a condition.

For example, an MPR based mitigation behavior may be provided, configured or indicated to the UE with respect to one of or a combination of the following conditions:
A symbol or slot type, e.g., a symbol/slot type ‘D’ or ‘F’ or ‘U’; or a symbol/slot of type SBFD, or of type ‘non-SBFD’, or ‘allowed’ or ‘not allowed’;
A transmission or allocation bandwidth corresponding to a carrier or an UL signal or UL channel;
A TRP, e.g., TRP A and/or TRP B, or a CORESETPoolIndex associated with CORESETs for PDCCH receptions, or a TRP identified by one or more SS/PBCH blocks (SSBs);
A number of symbol or slots, e.g., number of consecutive symbols or slots, or number of symbols or slots in a period;
A set of symbol/slot identifiers, e.g., a bitmap, or a list of symbols/slots, or a resource indicator value such as SLIV with starting slot/symbol value and a run length value in an index representation;
An UL signal or channel type, e.g., PUCCH, PUSCH, PRACH or SRS;
A transmission format of an UL signal or UL channel such as PUSCH, or PUCCH, or PRACH, or SRS; and
A limit value, e.g., a maximum or a minimum UL transmission power with respect to a carrier or a band or a maximum power difference with respect to a first and a second UL carrier or band.

In one example, the UE is indicated by the gNB with a slot/symbol type in a carrier or in a band of a band combination for which P-MPR based mitigation is allowed or not allowed. For example, the UE may be indicated a slot/symbol type on which a P-MPR based mitigation may be applied under certain conditions such as when a maximum UL duty cycle is exceeded. For example, the UE may be provided with a P-MPR based mitigation from the gNB wherein a slot/symbol type ‘U’ may correspond to ‘allowed’ and a slot/symbol type ‘F’ may correspond to ‘not allowed. The UE then may apply P-MPR to determine a maximum output power in the slot/symbol ‘U’, but the UE doesn't apply P-MPR to determine a maximum output power in the slot/symbol type ‘F’.

In one example, a condition associated with a P-MPR based mitigation may correspond to a minimum number TH for the number of RBs S of a PUSCH allocation on a symbol in a slot in a band of the band combination. The UE may apply P-MPR based mitigation to determine an UL transmission power in the slot in the band when the number S of RBs which is indicated or provided to the UE for the PUSCH allocation on a symbol in the slot is equal to or larger than the minimum number TH; otherwise, the UE does not apply the P-MPR based mitigation to determine the UL transmission power.

In one example, a condition associated with a P-MPR based mitigation may correspond to a maximum number TH for the number of RBs S of a PUSCH allocation on a symbol in a slot in a band of the band combination. The UE may apply P-MPR based mitigation to determine an UL transmission power in the slot in the band when the number S of RBs which is indicated or provided to the UE for the PUSCH allocation on a symbol in the slot is less than a maximum number TH; otherwise, the UE does not apply the P-MPR based mitigation to determine the UL transmission power.

For example, the UE may be indicated by the gNB with an MPR based mitigation behavior to apply on a carrier or in a band of the band combination wherein the P-MPR based mitigation corresponds to a provided set of time-domain resources, i.e., a set of slots/symbols on the carrier or in the band. The UE may apply the P-MPR based mitigation to determine an UL transmission power in the provided set of slots/symbols, respectively, on the carrier or in the band, but the UE does not apply P-MPR based mitigation to time-domain resources in the carrier or band which are not indicated. For example, a set of slots/symbols associated with an MPR mitigation behavior may be provided to the UE by higher layers. For example, a DCI-based indication may be used to provide the UE with information for the set of slots/symbols associated with an MPR mitigation behavior. For example, the set of slots/symbols associated with an MPR mitigation behavior may be tabulated and/or listed by system operating specifications. One or a combination of these methods may be used. For example, a first and a second set of slots/symbols on a serving cell associated an MPR mitigation behavior may be configured or indicated to the UE, respectively. For example, a set of symbols/slots or a set of symbol/slot identifiers associated with a set of slots/symbols may correspond to a bitmap or a list of slots/symbols or a SLIV value with a start and run length number of slots/symbols. For example, a set of symbols/slots may be provided to the UE as a type ‘valid’ or “invalid’ with respect to an allowed or a disallowed MPR mitigation behavior in a symbol/slot. For example, a set of symbols/slots may be provided to the UE as an assumed or as an indicated reference serving cell UL/DL configuration with respect to 4G/LTE radio access, or as an assumed or as an indicated reference UL/DL configuration with respect to 5G/NR or 6G radio access such as provided in an assumed or indicated tdd-UL-DL-ConfigurationCommon or tdd-UL-DL-ConfigurationDedicated including a set of symbol types ‘D, or ‘U, or ‘F’. For example, a set of symbol/slot identifiers associated with a set of slots/symbols may be indicated to the UE by DCI or provided to the UE by higher layer signaling such as RRC or by MAC CE.

In one example, a condition associated with an MPR mitigation behavior or P-MPR based mitigation may be associated with an UL signal or channel type such as corresponding to PUCCH, PUSCH, SRS or PRACH or may be associated with a transmission format of an UL signal or UL channel in a band of the band combination. For example, a transmission format with respect to PUSCH may correspond to one or a combination of the following, an RB allocation, a symbol allocation, a modulation scheme, a modulation order, an MCS, a TBS, a channel coding type or rate, a payload type such as data or UCI/control, a UCI/control payload type such as A/N, or CSI, or CSI part 1, or CSI part 2, or a UCI/control reporting type such as periodic, or semi-persistent, or aperiodic CSI report in the control payload.

For example, a condition or a restriction may correspond to a minimum MCS level TH for the PUSCH transmission in a slot. The UE may apply P-MPR based mitigation to determine an UL transmission power of a PUSCH transmission in the carrier or band when the MCS for the PUSCH transmission in the band is equal to or larger than the minimum UL MCS level TH, otherwise the UE does not apply P-MPR based mitigation to the PUSCH transmission in the band.

For example, a condition or a restriction may correspond to UCI/control payload type for the PUSCH transmission in a band. The UE may apply P-MPR based mitigation to determine an UL transmission power of a PUSCH transmission in the carrier or band when the UCI/control payload of the PUSCH comprises a CSI or CSI part 1 or CSI part 2; otherwise, e.g., when the UCI/payload of the PUSCH comprises HARQ-ACK information, the UE does not apply P-MPR based mitigation to the PUSCH transmission in the band.

In one example, a condition associated with a P-MPR based mitigation behavior may correspond to a maximum power difference D between a first UL transmission power in a first carrier or band and a second UL transmission power in a second carrier or band of the band combination. The UE may apply P-MPR based mitigation to determine an UL transmission power in a carrier or band when the resulting maximum power difference D between an UL transmission power in the first carrier or band and an UL transmission power in the second carrier or band is less than D; otherwise, the UE does not apply the P-MPR based mitigation to determine the UL transmission power, or the UE may reduce the P-MPR value such that the maximum power difference D is not exceeded.

In one example, a condition associated with a P-MPR based mitigation may correspond to a maximum power difference D between a first P-MPR value to determine an UL transmission power in a first carrier or band and a second P-MPR value to determine an UL transmission power in a second carrier or band of the band combination. The UE may apply the first P-MPR value to determine an UL transmission power in the first carrier or band when the resulting maximum power difference D between the first P-MPR value in the first carrier or band and the second P-MPR value in the second carrier or band is less than D; otherwise, the UE does not apply the first P-MPR value to determine the UL transmission power in the first carrier or band, or the UE may reduce the first P-MPR value such that the maximum power difference D with respect to the second P-MPR value is not exceeded.

In one embodiment the UE is provided with information for an MPR based mitigation behavior or P-MPR based mitigation to apply for a first or a second carrier or band of a band combination for a duration; wherein at least one carrier or band is indicated for 6G radio access. Based on the provided information, the UE determines a start timing and/or an end timing for the duration to apply a P-MPR based mitigation in a carrier or in a band of the band combination.

For example, a P-MPR based mitigation associated with a duration may be provided or indicated to the UE by the gNB based on one of or a combination of DCI-based signaling, L1 control signaling, RRC signaling, or MAC CE signaling, or NAS based signaling. For example, a P-MPR based mitigation corresponding to the first or the second carrier or band may be provided by system operating specifications. For example, a duration associated with a P-MPR based mitigation may be provided to the UE by higher layers. For example, a DCI-based indication may be used to provide the UE with a duration associated with a P-MPR based mitigation. For example, a duration associated with a P-MPR based mitigation may be tabulated and/or listed by system operating specifications.

In one example, an MPR based mitigation behavior or P-MPR based mitigation may be associated with duration T during which a P-MPR based mitigation corresponding to UL transmission in a carrier or in a band of a band combination can be applied by the UE with respect to a timing not earlier than a start timing or not later than an end timing based on the duration T. The UE may apply the P-MPR based mitigation to determine an UL transmission power corresponding to an UL transmission in the carrier or band when the UL transmission occurs during the duration T. A suitably selected reference timing may be chosen. For example, a duration T corresponding to UL transmissions when a P-MPR based mitigation may be applied by the UE after receiving an indication from the gNB may correspond to a timing of TH msec or of TH symbols/slots/subframes.

In one example, the UE is provided with information for an MPR based mitigation behavior or P-MPR based mitigation corresponding to a first duration associated with UL transmissions in a first carrier or band and a second duration associated with UL transmissions corresponding to a second carrier or band, respectively, of the band combination. The UE may apply P-MPR based mitigation to determine an UL transmission power for UL transmissions occurring in the first carrier or band during the first duration, and/or the UE may apply P-MPR based mitigation to determine an UL transmission power for UL transmissions occurring in the second carrier or band during the second duration. A value for a first and a second duration may be the same or different values can be associated with the first carrier or band, e.g., the 5G/NR or 6G carrier or band, and with the second carrier or band, e.g., the 6G carrier or band, respectively, of the band combination. For example, a value for a duration may correspond to time period or a time duration. For example, a value for a first or a second duration may be determined based on a minimum, or a maximum, or a scaling value, or an offset value, or a threshold value. For example, a minimum, or a maximum, or an adjusted or an assumed value for the second duration to determine an UL transmission power for an UL transmission in a second carrier or band may be determined with reference to value of a first duration. For example, a first duration where P-MPR based mitigation may be applied by the UE when a condition is met such as a maximum UL duty cycle is exceeded to determine an UL transmission power in a first FR2 band using 5G/NR or 6G radio access may correspond to a minimum value, e.g., T_{5G}=1 sec but a separate duration for a second FR2 band using 6G radio access in the band combination may correspond to T_{6G}=0.5 sec. For example, a default value for duration associated with a first or a second carrier or band in the band combination may be provided/indicated to the UE or may be tabulated or provided by system operating specifications.

In one embodiment the UE is provided with information for an MPR based mitigation behavior or P-MPR based mitigation to apply for a first or a second carrier or band of a band combination with respect to an activation timing; wherein at least one band is indicated for 6G radio access. Based on the information provided, the UE determines a start timing and/or an end timing for the duration to apply a P-MPR based mitigation to determine an UL transmission power corresponding to an UL transmission in a carrier or band of the band combination.

For example, a P-MPR based mitigation associated with an activation timing may be provided or indicated to the UE by the gNB based on one of or a combination of DCI-based signaling, L1 control signaling, RRC signaling, or MAC CE signaling, or NAS based signaling. For example, a P-MPR based mitigation corresponding to the first or the second carrier or band may be provided by system operating specifications. For example, an activation timing associated with a P-MPR based mitigation may be provided to the UE by higher layers. For example, a DCI-based indication may be used to provide the UE with an activation timing associated with a P-MPR based mitigation. For example, an activation timing associated with a P-MPR based mitigation may be tabulated and/or listed by system operating specifications.

In one example, a P-MPR based mitigation may be associated with an activation timing TH corresponding to a start timing after which a P-MPR based mitigation to determine an UL transmission power for an UL transmission in a carrier or band of a band combination may be applied by the UE. The UE may apply P-MPR based mitigation to an UL transmission in the carrier or in the band with respect to a suitably selected reference timing. For example, a first UL transmission in which to apply the P-MPR based mitigation to determine an UL transmission power in the carrier or in the band after receiving an indication from the gNB may correspond to a timing of TH msec or TH symbols after reception of a first or a last symbol of a PDCCH in which the indication was received by the UE.

Similar considerations with respect to a duration or an activation timing based on the examples can be applied to other cases such as other FR1 or FR2 or FR3 UE Power Classes such as FR2 PC1 or FR1 PC2, or to other cases such as when the UE operates 5G/NR radio access and 6G radio access in a same frequency range such as within FR1, or within FR2, or within FR3, or to other cases such as when the UE operates 5G/NR radio access and 6G radio access across frequency ranges such as across FR1 and FR2, or across FR2 and FR3, or to other cases such as when the UEs operates 4G/LTE radio access or 6G radio access instead of 5G/NR radio access with 6G radio access.

In one embodiment, the UE may be provided with information by the gNB for an MPR based mitigation behavior or P-MPR based mitigation associated with a first or a second carrier or band of the band combination using one of or a combination of DCI-based signaling, L1 control signaling, RRC signaling, or MAC CE signaling, or NAS based signaling. For example, a P-MPR based mitigation behavior or P-MPR based mitigation corresponding to the first or the second carrier or band may be provided by system operating specifications.

For example, a configuration associated with a P-MPR based mitigation may be provided to the UE by higher layers. For example, a DCI-based indication may be used to provide the UE with information associated with P-MPR based mitigation. For example, a P-MPR based mitigation may be tabulated and/or listed by system operating specifications. A configuration for a P-MPR based mitigation may be provided by higher layers to the UE and used in conjunction with DCI-based indication by the UE to determine a P-MPR based mitigation or to apply P-MPR based mitigation. For example, a DCI can indicate a P-MPR based mitigation from a set of RRC-configured MPR mitigation behaviors. If a same MPR based mitigation behavior or P-MPR based mitigation can be provided for multiple UEs, a common DCI or common RRC signaling message may be used. A UE-specific DCI or RRC signaling of dedicated or common type may be used to provide information associated with a P-MPR based mitigation to a UE. A value or a set of values may be associated with a parameter for a P-MPR based mitigation. For example, a UE may select or determine a value from the set of values associated with a P-MPR based mitigation based on an index value indicated through a DCI format or through MAC-CE signaling wherein the UE may select from one or more entries provided in an RRC configurable table associated with an index value. The UE may determine a default condition or a default value associated with a P-MPR based mitigation.

In one example, a P-MPR based mitigation behavior or P-MPR based mitigation is provided to the UE using higher layer signaling. For example, a UE may be provided with a configuration of a P-MPR based mitigation based on a higher layer parameter such as ServingCellConfig or PUSCH-Config.

In one example, a PUSCH time-domain resource allocation (TDRA) table may be configured for the UE by higher layers and include a parameter associated with a P-MPR based mitigation. For example, the PUSCH time-domain resource allocation table may be configured for the UE by higher layers and include a parameter associated with a P-MPR based mitigation, e.g., for a row of the PUSCH TDRA table or as a parameter provided in the configuration for the PUSCH TDRA table. For example, the UE may be indicated an entry of the PUSCH TDRA table associated with a P-MPR based mitigation using a TDRA field in a DCI format. For example, a PUSCH TDRA table associated with a P-MPR based mitigation corresponding to an UL transmission may be used based on a configured grant.

In one example, a power control configuration may be provided to the UE by higher layers or tabulated by system operating specifications and include a parameter associated with a P-MPR based mitigation. For example, the power control configuration may include a closed loop TPC adjustment value such as +1 dB or −3 dB and include a parameter associated with a P-MPR based mitigation. For example, the UE may be indicated an entry of the power control configuration associated with a P-MPR based mitigation using a TPC command for scheduled PUSCH field in a DCI format or using a dedicated field in the DCI format.

In one example, information may be provided to the UE by higher layers to associate a DL or UL reference signal or a DL or an UL or joint TCI state(s) or RS resource index(es) such as corresponding to an SSB or to a CSI-RS resource index with a P-MPR based mitigation for an UL transmission. For example, a first TCI state may correspond to an UL transmission for a P-MPR based mitigation in a first band, and a second TCI state may correspond to an UL transmission for a second a P-MPR based mitigation in a second band, wherein the first and second bands can be same or different. For example, a PUSCH transmission scheduled by a DCI format in a PDCCH can be associated with a P-MPR based mitigation in a first band when the PDCCH is received in a CORESET with a first value for CORESETPoolIndex, and be associated with a second P-MPR based mitigation in a second band when the PDCCH is received in a CORESET with a second value for CORESETPoolIndex, wherein the first and second bands can be same or different.

Similar considerations can be applied to other cases such as when an MPR mitigation behavior or P-MPR based mitigation is provided to the UE using CN based signaling or to other cases such as when an MPR based mitigation behavior or P-MPR based mitigation may be provided, e.g., stored or provisioned for the UE based on a USIM/UICC and related protocol signaling.

In one embodiment, the UE may indicate or report to the gNB a supported MPR based mitigation behavior or P-MPR based mitigation for a band using 6G radio access in a band combination using higher layer signaling such as an RRC UECapabilityInformation message. For example, the UE may indicate or report to the gNB a supported MPR mitigation behavior associated with operation in an FR2 6G band or band combination in UE radio access capability information. For example, a gNB may initiate a procedure using a UECapabilityEnquiry message.

In one example, the UE indicates or reports to the gNB a supported MPR mitigation behavior for the bands in a band combination in a UE radio access capability information wherein the MPR mitigation behavior may correspond to a same, or a separate, or a joint or common type of P-MPR based mitigation for the bands in the band combination; and wherein one or more bands may use 6G radio access.

In one example, the UE indicates or reports to the gNB a duration or a value for an activation timing associated with an MPR mitigation behavior or P-MPR based mitigation for the bands in a band combination wherein one or more bands may use 6G radio access.

In one example, the UE indicates or reports to the gNB a supported MPR mitigation behavior for a first or a second band in the band combination in a UE radio access capability information wherein the MPR mitigation behavior corresponds to an ordering or a sequence of carriers or bands corresponding to which the UE may apply P-MPR based mitigation, e.g., indicative of a carrier or a band in the band combination based on which P-MPR based mitigation may be applied first or last by the UE; wherein one or more bands may use 6G radio access.

For example, the UE may indicate to the gNB a desired, a preferred, or a priority-based MPR mitigation behavior for a band using 6G radio access in a band combination using higher layer signaling such as a higher layer RRC UEAssistanceInformation message, wherein one or more bands may use 6G radio access.

In one example, the UE indicates to the gNB a desired or a preferred MPR mitigation behavior or P-MPR based mitigation for a first and/or a second band in a band combination including a band using 6G radio access wherein the MPR mitigation behavior may correspond to a same, or a separate, or a joint or common type of MPR mitigation behavior.

In one example, the UE indicates to the gNB a desired or a preferred MPR based mitigation behavior or P-MPR based mitigation for a first or a second band in the band combination in a UE radio access capability information wherein the MPR based mitigation behavior corresponds to an ordering or a sequence of carriers or bands corresponding to which the UE may apply an P-MPR based mitigation, e.g., indicative of a carrier or a band in the band combination on which P-MPR based mitigation may be applied first or last by the UE; wherein one or more bands may use 6G radio access.

In one example, the UE indicates or reports to the gNB a value for a first P-MPR associated with UL transmissions in a first 5G/NR or 6G band and a value for a second P-MPR associated with UL transmissions in a second 6G band, respectively, wherein the first or the second band may correspond to an FR1, or an FR2, or an FR3 band.

Similar considerations based on the examples provided for the RRC UECapabilityInformation or UECapabilityEnquiry messages can be applied to other cases such as other FR1 or FR2 or FR3 UE Power Classes, or to other cases such as when the UE operates 5G/NR or 6G radio access and 6G radio access in a same frequency range such as within FR1, or within FR2, or within FR3, or to other cases such as when the UE operates 5G/NR or 6G radio access and 6G radio access across frequency ranges such as across FR1 and FR2, or across FR2 and FR3, or to other cases such as when the UEs operates 4G/LTE radio access instead of 5G/NR radio access with 6G radio access.

In one embodiment, the UE is provided with an adjustment factor to determine an allowable RF exposure for a first carrier or band with respect to a second carrier or band of a band combination to determine a P-MPR value. Based on the adjustment or scaling value, the UE may determine an estimated or assumed or equivalent power or energy contribution for a second carrier or band using UL transmissions in a first carrier or band and the adjustment factor to determine a maximum output power or to determine an average UL transmit power level in a period or to determine a P-MPR value corresponding to MPR based mitigation behavior or to P-MPR based mitigation.

For example, the UE may determine an amount of allowable RF exposure such as MPE for a next period of time such as the next several hundred msec or the next 1 sec. The UE may use an estimated, e.g., an allowable RF exposure limit to determine a maximum output power while adhering to the parameterization and closed-loop power-control commands from the gNB according to the UL transmit power control procedure. When transmitting an UL signal or channel in the first carrier or band such as an FR2 band corresponding to 5G/NR or 6G radio access, the UE determines an equivalent power or energy contribution resulting from the UL transmissions in the first carrier or band and using the adjustment factor corresponding to MPR based mitigation behavior or to P-MPR based mitigation to determine an estimated or assumed or equivalent power or energy contributions with respect to an assumed or an actual UL transmissions in the second carrier or band such as an FR2 band corresponding to 6G radio access to determine an allowable RF exposure limit. For example, the adjustment value may correspond to a scaling value, or an offset value, or a threshold value corresponding to an allowable RF exposure limit. For example, an UL transmission may correspond to an UL transmission of one or a combination of UL signals or channels, i.e., a PUSCH, or a PUCCH, or a PRACH, or an SRS.

In one embodiment, the UE provides a serving gNB with information using a Power Headroom reporting procedure or a Power Headroom Report (PHR) to indicate information associated with an MPR mitigation behavior, or P-MPR based mitigation, or a P-MPR value for a first or for a second band, respectively, in a band combination to the gNB.

For example, a PHR associated with a P-MPR based mitigation or a P-MPR value in a band or for the band combination may be triggered, i.e., by an event such as change of a P-MPR value or a change of the P-MPR based mitigation, or may be reported according to a timer value. For example, the UE may indicate to the gNB a change of an applied or a selected or a resulting P-MPR value in a band or in a band combination in a PHR. For example, the UE may indicate to the gNB an assumed or a selected or a reference MPR mitigation behavior (or P-MPR mitigation mode) in a PHR wherein a P-MPR based mitigation may correspond to a same, or a separate, or a joint/common type of MPR mitigation behavior. For example, the UE may indicate to the gNB an applied or a selected or a resulting P-MPR value in a band or in a band combination in a PHR according to a provided reporting time interval for the PHR such as based on a parameter phr-PeriodicTimer.

For example, a PHR associated with an MPR mitigation behavior, P-MPR based mitigation, or a P-MPR value for a band or a band combination may correspond to a Type 1, or a Type 2, or a Type 3 PHR. In one example, using a Type 1 PHR, the UE may indicate the difference between the nominal UE maximum transmit power and the estimated power for an UL-SCH transmission per activated Serving Cell corresponding to an applied or a selected or a resulting P-MPR value. In one example, using a Type 2 PHR, the UE may indicate the difference between a nominal UE maximum transmit power and the estimated power for an UL-SCH or PUCCH transmission on SpCell of the other MAC entity, i.e., a 4G/LTE MAC entity, or a 5G/NR MAC entity, or a 6G MAC entity corresponding to an applied or a selected or a resulting P-MPR value. In one example, using a Type 3 PHR, the UE may indicate the difference between the nominal UE maximum transmit power and the estimated power for SRS transmission corresponding to an applied or a selected or a resulting P-MPR value. For example, information corresponding to an applied or a selected or a resulting P-MPR value or a P-MPR based mitigation may be included in a PHR based on a field or a value of a field in the PHR. For example, one or multiple PHR values/fields corresponding to a P-MPR based mitigation or a P-MPR value may be included in a PHR report from the UE. For example, a PHR format may correspond to a combination of one or more MAC CE field(s), PHR reporting mode(s), associated timer value(s), or a PHR configuration. For example, a PHR with respect to a first band and a second band, respectively, in a band combination may be separately parameterized. In one example, a first PHR format may be provided for an actual or reference PUSCH or an SRS transmission in a first band of a band combination using a first associated timer value such as phr-PeriodicTimer=‘sf100’, and a second PHR format may be provided for an actual or reference PUSCH or an SRS transmission in a second band of the band combination using a same value or another value for an associated reporting timer such as phr-PeriodicTimer=‘sf20’.

For example, the UE can be provided by higher layers with information to enable or disable PHR for an actual PUSCH transmission, or for a transmission based on a reference PUSCH format with respect to the first band, or with respect to the second band, or with respect to any band, or for none of the bands in a band combination. The UE may then determine a band in the band combination for which PHR is reported.

For example, the UE can be provided information that PHR of an actual or a reference PUSCH transmission or an SRS transmission is disabled for a carrier in a band corresponding to 5G/NR or 6G radio access but enabled for a carrier in a band corresponding to 6G radio access in a band combination. For example, the UE can be provided information that PHR of an actual or a reference PUSCH transmission or an SRS transmission is enabled for a carrier in the band corresponding to 5G/NR or 6G radio access and for a carrier in the band corresponding to 6G radio access in a band combination.

For example, a PHR corresponding to P-MPR based mitigation or a P-MPR value from the UE may be triggered when one or more of the following events occur: aphr-ProhibitTimer expires or has expired and the path loss has changed more than phr-Tx-PowerFactorChange dB for at least one activated Serving Cell; a phr-PeriodicTimer expires; upon configuration or reconfiguration of the power headroom reporting functionality by upper layers, which is not used to disable the function; a phr-ProhibitTimer expires or has expired when the MAC entity has UL resources for new transmission; and power headroom reporting on the UL resource is enabled by higher layers.

For example, the UE may determine a first PHR format PHR₁ for an actual or a reference PUSCH transmission or a second PHR format PHR₂ for an actual or a reference PUSCH transmission on a serving cell on a carrier in the first band and on a carrier in the second band, respectively, of the band combination. The first PHR format PHR₁ for an actual or a reference PUSCH transmission for a serving cell may be associated with PUSCH transmissions by the UE in a carrier corresponding to 5G/NR or 6G radio access. The second PHR format PHR₂ for an actual or a reference PUSCH transmission on a serving cell may be associated with PUSCH transmissions by the UE in a carrier corresponding to 6G radio access. The UE may use a PHR format to provide PHR for actual or reference PUSCH transmission(s) in one or multiple slots of a carrier where the PHR format may include PHR value(s) and/or an associated MPR mitigation behavior or P-MPR based mitigation.

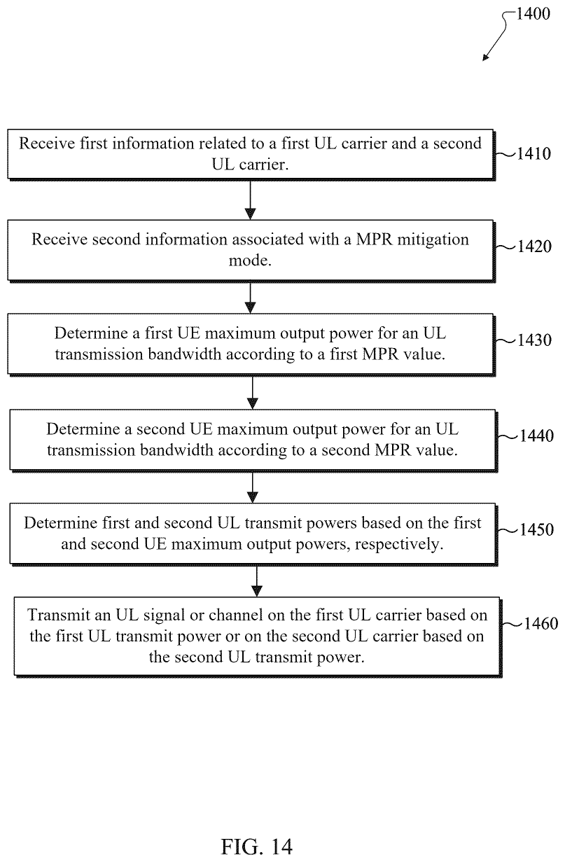

FIG. 14 illustrates an example method 1400 performed by a UE in a wireless communication system according to embodiments of the present disclosure. The method 1400 of FIG. 14 can be performed by any of the UEs 111-114 of FIG. 1, such as the UE 114 of FIG. 3, and a corresponding method can be performed by any of the BSs 101-103 of FIG. 1, such as BS 102 of FIG. 2. The method 1400 is for illustration only and other embodiments can be used without departing from the scope of the present disclosure.

The method 1400 begins with the UE receiving first information related to a first UL carrier and a second UL carrier (1410). In various embodiments, the first information is associated with UL carrier aggregation. In various embodiments, a time-domain resource from a first or second subset of slots on the first or second UL carrier is indicated for simultaneous transmission and reception during the same time-domain resource on a cell. The UE then receives second information associated with a MPR mitigation mode (1420).

The UE then determines a first UE maximum output power for an UL transmission bandwidth according to a first MPR value (1430). For example, in 1430, the determination is made based on the first and second information and the first MPR value is associated with a first transmission on the first UL carrier. The UE then determines a second UE maximum output power for an UL transmission bandwidth according to a second MPR value (1440). For example, in 1430, the determination is made based on the first and second information and the second MPR value is associated with a second transmission on the second UL carrier. In various embodiments, the second information includes an indication corresponding to the MPR mitigation mode. The UE determines the first or second MPR value including to determine an UL duty cycle of the first or second UL carrier based on the indication. In various embodiments, the first or second information includes maximum values for the first and second MPR values.

The UE then determines first and second UL transmit powers based on the first and second UE maximum output powers, respectively (1450). The UE then transmits an UL signal or channel on the first UL carrier based on the first UL transmit power or on the second UL carrier based on the second UL transmit power (1460). In various embodiments, the UE transmits, via UCI, a MAC CE, or a RRC message, values for first and second supported or indicated MPR mitigation mode corresponding to the first and second UL carriers, respectively, or a value for a supported or indicated MPR mitigation corresponding to the first and second UL carriers.

In various embodiments, the MPR mitigation mode corresponds to a jointly determined MPR value for the first transmission on the first UL carrier and for the second transmission on the second UL carrier in a same time-domain resource. The UE determines the jointly determined MPR value as one of the first MPR value for the first transmission when the second transmission would not occur during the first transmission, the second MPR value for the second transmission when the first transmission would not occur during the second transmission, a maximum value of the first and second MPR values for both the first transmission and the second transmission when the first transmission and the second transmission would occur during a same time-domain resource, or a scaled value, an adjusted value, or a weighted average value based on the first or second MPR values using an adjustment factor when the first transmission and the second transmission would occur during a same time-domain resource.

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A method for operating a user equipment (UE), the method comprising:
receiving first information related to a first uplink (UL) carrier and a second UL carrier;
receiving second information associated with a maximum power reduction (MPR) mitigation mode;
determining, based on the first and second information, a first UE maximum output power for an UL transmission bandwidth according to a first MPR value, wherein the first MPR value is associated with a first transmission on the first UL carrier;
determining, based on the first and second information, a second UE maximum output power for an UL transmission bandwidth according to a second MPR value, wherein the second MPR value is associated with a second transmission on the second UL carrier;
determining a first UL transmit power and a second UL transmit power based on the first and second UE maximum output powers, respectively; and
one of:
transmitting, based on the first UL transmit power, an UL signal or channel on the first UL carrier; or
transmitting, based on the second UL transmit power, the UL signal or channel on the second UL carrier.

2. The method of claim 1, wherein:
the MPR mitigation mode corresponds to a joint MPR value for the first transmission on the first UL carrier and for the second transmission on the second UL carrier in a time-domain resource,
the method further comprises determining the joint MPR value as one of:
the first MPR value for the first transmission when the second transmission would not occur during the first transmission,
the second MPR value for the second transmission when the first transmission would not occur during the second transmission,
a maximum value of the first and second MPR values for both the first transmission and the second transmission when the first transmission and the second transmission would occur during a same time-domain resource, or
a scaled value, an adjusted value, or a weighted average value based on the first or second MPR values using an adjustment factor when the first transmission and the second transmission would occur during a same time-domain resource.

3. The method of claim 1, wherein the first information is associated with UL carrier aggregation.

4. The method of claim 1, wherein a time-domain resource from a first or second subset of slots on the first or second UL carrier is indicated for simultaneous transmission and reception during the same time-domain resource on a cell.

5. The method of claim 1, wherein:
the second information includes an indication corresponding to the MPR mitigation mode, and
the method further includes determining the first or second MPR value including determining an UL duty cycle of the first or second UL carrier based on the indication.

6. The method of claim 1, further comprising transmitting, via uplink control information (UCI), a medium-access-control (MAC) control element (CE), or a radio resource control (RRC) message, (i) values for first and second supported or indicated MPR mitigation mode corresponding to the first and second UL carriers, respectively, or (ii) a value for a supported or indicated MPR mitigation corresponding to the first and second UL carriers.

7. The method of claim 1, wherein the first or second information includes maximum values for the first and second MPR values.

8. A user equipment (UE), comprising:
a transceiver configured to:
receive first information related to a first uplink (UL) carrier and a second UL carrier; and
receive second information associated with a maximum power reduction (MPR) mitigation mode; and
a processor operably coupled to the transceiver, the processor configured to:
determine, based on the first and second information, a first UE maximum output power for an UL transmission bandwidth according to a first MPR value, wherein the first MPR value is associated with a first transmission on the first UL carrier;
determine, based on the first and second information, a second UE maximum output power for an UL transmission bandwidth according to a second MPR value, wherein the second MPR value is associated with a second transmission on the second UL carrier; and
determine a first UL transmit power and a second UL transmit power based on the first and second UE maximum output powers, respectively,
wherein the transceiver is further configured to one of:
transmit, based on the first UL transmit power, an UL signal or channel on the first UL carrier; or
transmit, based on the second UL transmit power, the UL signal or channel on the second UL carrier.

9. The UE of claim 8, wherein:
the MPR mitigation mode corresponds to a joint MPR value for the first transmission on the first UL carrier and for the second transmission on the second UL carrier in a time-domain resource,
the processor is further configured to determine the joint MPR value as one of:
the first MPR value for the first transmission when the second transmission would not occur during the first transmission,
the second MPR value for the second transmission when the first transmission would not occur during the second transmission,
a maximum value of the first and second MPR values for both the first transmission and the second transmission when the first transmission and the second transmission would occur during a same time-domain resource, or
a scaled value, an adjusted value, or a weighted average value based on the first or second MPR values using an adjustment factor when the first transmission and the second transmission would occur during a same time-domain resource.

10. The UE of claim 8, wherein the first information is associated with UL carrier aggregation.

11. The UE of claim 8, wherein a time-domain resource from a first or second subset of slots on the first or second UL carrier is indicated for simultaneous transmission and reception during the same time-domain resource on a cell.

12. The UE of claim 8, wherein:
the second information includes an indication corresponding to the MPR mitigation mode, and
the processor is further configured to determine the first or second MPR value including to determine an UL duty cycle of the first or second UL carrier based on the indication.

13. The UE of claim 8, wherein the transceiver is further configured to transmit, via uplink control information (UCI), a medium-access-control (MAC) control element (CE), or a radio resource control (RRC) message, (i) values for first and second supported or indicated MPR mitigation mode corresponding to the first and second UL carriers, respectively, or (ii) a value for a supported or indicated MPR mitigation corresponding to the first and second UL carriers.

14. The UE of claim 8, wherein the first or second information includes maximum values for the first and second MPR values.

15. A base station (BS), comprising:
a processor; and
a transceiver operably coupled to the processor, the transceiver configured to:
transmit, to a user equipment (UE), first information related to a first uplink (UL) carrier and a second UL carrier;
transmit, to the UE, second information associated with a maximum power reduction (MPR) mitigation mode; and
one of:
receive an UL signal or channel on the first UL carrier, the UL signal or channel transmitted based on a first UL transmit power; or
receive the UL signal or channel on the second UL carrier, the UL signal or channel transmitted based on a second UL transmit power,
wherein the first and second information indicate a first UE maximum output power for an UL transmission bandwidth according to a first MPR value,
wherein the first MPR value is associated with a first transmission on the first UL carrier,
wherein the first and second information indicate a second UE maximum output power for an UL transmission bandwidth according to a second MPR value,
wherein the second MPR value is associated with a second transmission on the second UL carrier, and
wherein the first UL transmit power and the second UL transmit power are based on the first and second UE maximum output powers, respectively.

16. The BS of claim 15, wherein:
the MPR mitigation mode corresponds to a joint MPR value for the first transmission on the first UL carrier and for the second transmission on the second UL carrier in a time-domain resource,
the joint MPR value is one of:
the first MPR value for the first transmission when the second transmission would not occur during the first transmission,
the second MPR value for the second transmission when the first transmission would not occur during the second transmission,
a maximum value of the first and second MPR values for both the first transmission and the second transmission when the first transmission and the second transmission would occur during a same time-domain resource, or
a scaled value, an adjusted value, or a weighted average value based on the first or second MPR values using an adjustment factor when the first transmission and the second transmission would occur during a same time-domain resource.

17. The BS of claim 15, wherein the first information is associated with UL carrier aggregation.

18. The BS of claim 15, wherein a time-domain resource from a first or second subset of slots on the first or second UL carrier is indicated for simultaneous transmission and reception during the same time-domain resource on a cell.

19. The BS of claim 15, wherein:
the second information includes an indication corresponding to the MPR mitigation mode, and
an UL duty cycle of the first or second UL carrier is based on the indication.

20. The BS of claim 15, the transceiver is further configured to receive, via uplink control information (UCI), a medium-access-control (MAC) control element (CE), or a radio resource control (RRC) message, (i) values for first and second supported or indicated MPR mitigation mode corresponding to the first and second UL carriers, respectively, or (ii) a value for a supported or indicated MPR mitigation corresponding to the first and second UL carriers.
